(19) United States
(12) Patent Application Publication
(10) Pub. No.: US 2026/0065361 A1
(43) Pub. Date: Mar. 5, 2026

(54) SYSTEM, METHOD, AND NON-TRANSITORY STORAGE MEDIUM

(71) Applicant: KONAMI DIGITAL ENTERTAINMENT CO., LTD., Tokyo (JP)

(72) Inventors: Takuro EIKA, Tokyo (JP); Akira SAKAI, Tokyo (JP)

(73) Assignee: KONAMI DIGITAL ENTERTAINMENT CO., LTD., Tokyo (JP)

(21) Appl. No.: 19/379,990

(22) Filed: Nov. 5, 2025

Related U.S. Application Data
(63) Continuation of application No. PCT/JP2024/014236, filed on Apr. 8, 2024.

(30) Foreign Application Priority Data
May 10, 2023 (JP) 2023-077978

(51) Int. Cl. G06Q 30/08

(52) U.S. Cl. CPC G06Q 30/08

(57) ABSTRACT

A system (1) includes: a listing medium information acquisition section (111) that acquires, from a listing user, information indicating a listing medium; a bid price information acquisition section (112) that acquires information indicating a bid price of a bid user; an immediate decision condition acquisition section (115) that acquires an immediate decision condition; a status information acquisition section (116) that acquires status information pertaining to an auction; an immediate decision instruction information acquisition section (117) that acquires immediate decision instruction information; an immediate decision management section (118) that, in a case where the status information has specific content, executes, on the basis of the immediate decision instruction information, the bid which satisfies the immediate decision condition; and a successful bid user determination section (119) that determines the bid user as a successful bid user on the basis of the bid which satisfies the immediate decision condition.

This application is a Continuation of PCT International Application No. PCT/JP2024/014236 filed in Japan on Apr. 8, 2024, which claims the benefit of Patent Application No. 2023-077978 filed in Japan on May 10, 2023, the entire contents of which are hereby incorporated by reference.

### TECHNICAL FIELD

The present invention relates to a technique for providing a service for carrying out a transaction through an auction.

### BACKGROUND ART

In an auction in which automated bidding is used, in a case where, for example, the number of bidders is excessively larger than the number of listings, a situation can occur in which a successful bid cannot be made depending on a timing even if a bidder intends to pay a higher price than other bidders. For example, in a case where the number of bidders is large, a bid price sometimes suddenly changes just before an end of a bidding period, and thus a situation can occur in which re-bidding is not in time for the end of the bidding period. Further, in an auction, there is a mechanism called an immediate decision in which, in a case where a bid is made at an amount set as a buyout price, a successful bid can be made without the need to wait for an end of a bidding period. Patent Literature 1 discloses a system for allowing a user who bids for a listed object at a buyout price to successfully bid for the listed object.

### CITATION LIST

### Patent Literature

### Patent Literature 1

Japanese Patent Application Publication Tokukai No. 2020-095642

### SUMMARY OF INVENTION

### Technical Problem

However, in the system disclosed in Patent Literature 1, in a bid in which such a buyout price is used, a successful bid may be made at an unnecessarily high price. For example, in an auction in which a buyout price is 30,000 yen, there can be a case where a successful bid is made at a buyout price of 30,000 yen for an object, for which a successful bid actually can be made at 1,000 yen, without knowing a market price. Thus, a successful bid in which a buyout price is used makes it possible to make a successful bid without fail, but may result in a purchase at an unnecessarily high price for a bidder. An object of an aspect of the present invention is to provide a system that enables an immediate decision in a desired situation.

### Solution to Problem

In order to attain the object, a system in accordance with an aspect of the present invention includes: a listing medium information acquisition section that acquires, from a listing user who lists at least one listing medium which is listed in an auction, listing medium information indicating the at least one listing medium; a bid price information acquisition section that acquires bid price information indicating a bid price of at least one bid user who bids in the auction; an immediate decision condition acquisition section that acquires immediate decision condition information indicating an immediate decision condition for determining a successful bid user who successfully bids for the at least one listing medium before a deadline set in advance as a bidding deadline for the auction expires; a status information acquisition section that acquires status information indicating a status of the auction; an immediate decision instruction information acquisition section that acquires immediate decision instruction information indicating an immediate decision instruction to, in a case where the status information has specific content set in advance, execute a bid which satisfies the immediate decision condition; an immediate decision management section that, in a case where the status information has the specific content set in advance, executes, on the basis of the immediate decision instruction information, the bid which satisfies the immediate decision condition; and a successful bid user determination section that, on the basis of the bid which has been executed by the immediate decision management section and which satisfies the immediate decision condition, determines, as a successful bid user who successfully bids for the at least one listing medium, the at least one bid user who is associated with the immediate decision instruction information.

In order to attain the object, a method in accordance with an aspect of the present invention is carried out by at least one computer, the method including: a listing medium information acquisition step of acquiring, from a listing user who lists at least one listing medium which is listed in an auction, listing medium information indicating the at least one listing medium; a bid price information acquisition step of acquiring bid price information indicating a bid price of at least one bid user who bids in the auction; an immediate decision condition acquisition step of acquiring immediate decision condition information indicating an immediate decision condition for determining a successful bid user who successfully bids for the at least one listing medium before a deadline set in advance as a bidding deadline for the auction expires; a status information acquisition step of acquiring status information indicating a status of the auction; an immediate decision instruction information acquisition step of acquiring immediate decision instruction information indicating an immediate decision instruction to, in a case where the status information has specific content set in advance, execute a bid which satisfies the immediate decision condition; an immediate decision management step of, in a case where the status information has the specific content set in advance, executing, on the basis of the immediate decision instruction information, the bid which satisfies the immediate decision condition; and a successful bid user determination step of, on the basis of the bid which has been executed by the immediate decision management step and which satisfies the immediate decision condition, determining, as a successful bid user who successfully bids for the at least one listing medium, the at least one bid user who is associated with the immediate decision instruction information.

In order to attain the object, a program in accordance with an aspect of the present invention causes at least one computer to carry out: a listing medium information acquisition step of acquiring, from a listing user who lists at least one listing medium which is listed in an auction, listing medium information indicating the at least one listing medium; a bid price information acquisition step of acquiring bid price information indicating a bid price of at least one bid user who bids in the auction; an immediate decision condition acquisition step of acquiring immediate decision condition information indicating an immediate decision condition for determining a successful bid user who successfully bids for the at least one listing medium before a deadline set in advance as a bidding deadline for the auction expires; a status information acquisition step of acquiring status information indicating a status of the auction; an immediate decision instruction information acquisition step of acquiring immediate decision instruction information indicating an immediate decision instruction to, in a case where the status information has specific content set in advance, execute a bid which satisfies the immediate decision condition; an immediate decision management step of, in a case where the status information has the specific content set in advance, executing, on the basis of the immediate decision instruction information, the bid which satisfies the immediate decision condition; and a successful bid user determination step of, on the basis of the bid which has been executed by the immediate decision management step and which satisfies the immediate decision a condition, determining, as successful bid user who successfully bids for the at least one listing medium, the at least one bid user who is associated with the immediate decision instruction information.

### Advantageous Effects of Invention

An aspect of the present invention makes it possible to provide a system that enables an immediate decision in a desired situation.

### BRIEF DESCRIPTION OF DRAWINGS

FIG. 1 is a block diagram illustrating an example of a configuration of a system in accordance with Embodiment 1 of the present invention.

FIG. 2 is a block diagram illustrating a functional configuration of an auction server in accordance with Embodiment 1 of the present invention.

FIG. 3 is a diagram illustrating an example of rank information in accordance with Embodiment 1 of the present invention.

FIG. 4 is a block diagram illustrating a functional configuration of a game server in accordance with Embodiment 1 of the present invention.

FIG. 5 is a block diagram illustrating a functional configuration of a listing user terminal in accordance with Embodiment 1 of the present invention.

FIG. 6 is a block diagram illustrating a functional configuration of a bid user terminal in accordance with Embodiment 1 of the present invention.

FIG. 7 is a diagram illustrating a flow of an information processing method in accordance with Embodiment 1 of the present invention.

FIG. 8 is a block diagram illustrating an example screen displayed on a display device of the listing user terminal in accordance with Embodiment 1 of the present invention.

FIG. 9 is a block diagram illustrating an example screen displayed on a display device of a bid user terminal in accordance with Embodiment 1 of the present invention.

FIG. 10 is a block diagram illustrating another example screen displayed on the display device of the bid user terminal in accordance with Embodiment 1 of the present invention.

FIG. 11 is a block diagram illustrating yet another example screen displayed on the display device of the bid user terminal in accordance with Embodiment 1 of the present invention.

FIG. 12 is a flowchart illustrating an example of a detailed flow of an automated bidding management process in accordance with Embodiment 1 of the present invention.

FIG. 13 is a diagram illustrating an example of the rank information updated in Embodiment 1 of the present invention.

FIG. 14 is a diagram illustrating another example of the rank information updated in Embodiment 1 of the present invention.

FIG. 15 is a diagram illustrating yet another example of the rank information updated in Embodiment 1 of the present invention.

FIG. 16 is a flowchart t illustrating an example of a detailed flow of an immediate decision management process in accordance with Embodiment 1 of the present invention.

### DESCRIPTION OF EMBODIMENTS

### Embodiment 1

A system 1 in accordance with the present embodiment will be described below in detail. The system 1 is a system for providing, on a network, a place for a transaction through an auction.

### <Configuration of System 1>

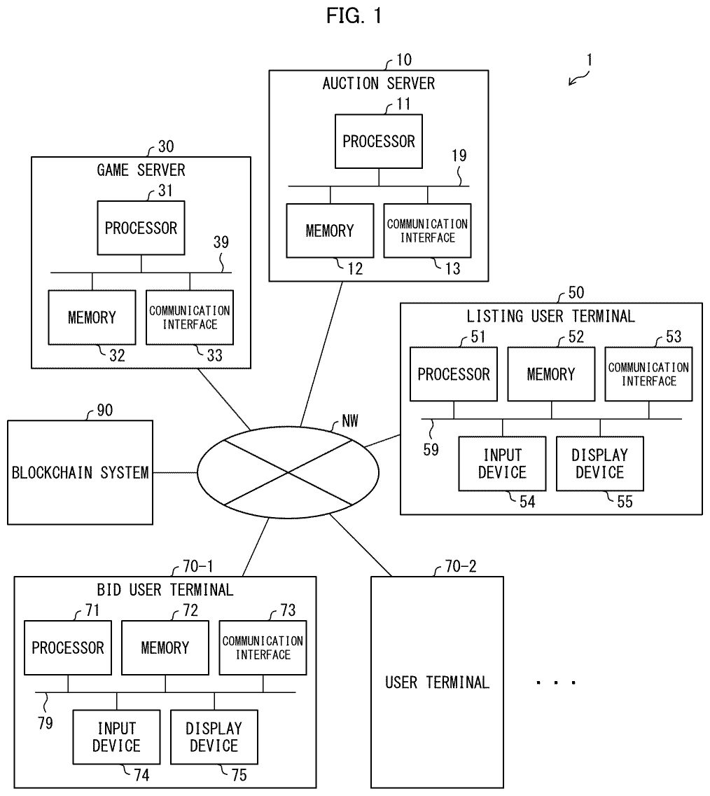

FIG. 1 is a block diagram illustrating an example of a configuration of the system 1. As illustrated in FIG. 1, the system 1 includes an auction server 10, a game server 30, a listing user terminal 50, bid user terminals 70-1, 70-2, . . . , and a blockchain system 90. In a case where it is not particularly necessary to distinguish and describe the bid user terminals 70-1, 70-2, . . . , the bid user terminals 70-1, 70-2, are each also referred to merely as a bid user terminal 70. These devices are connected via a network NW so as to be capable of communicating with each other. The network NW includes, for example, the Internet, but is not limited to this. FIG. 1 illustrates two bid user terminals 70. However, the number of bid user terminals 70 included in the system 1 may be three or more. FIG. 1 illustrates one auction server 10, one game server 30, one listing user terminal 50, and one blockchain system 90. However, the numbers of devices included in the system 1 each may be two or more.

The auction server 10 is a device that manages an auction carried out on a network. The game server 30 is a device that advances a game by executing a game program. Note that a part of the game program may be executed by another device (for example, the listing user terminal 50, the bid user terminal 70, or the like) different from the game server 30. The game server 30 advances the game with use of a game medium on the basis of an operation by a user. The game medium can be an example of a listing medium that is listed in the auction. The system 1 may include a plurality of game servers 30 that advance different types of games. The listing user terminal 50 is a terminal used by a listing user who lists the listing medium in the auction. The bid user terminal 70 is a terminal used by a bid user who bids in the auction. The blockchain system 90 is a device that stores a non-fungible token (“hereinafter “NFT”) associated with the listing medium. Note that the NFT need not necessarily be associated with the listing medium.

The listing user may be an operator on a management side of a game advanced by the game server 30. In this case, the listing user terminal 50 may be a management terminal that manages the game server 30. The listing user and/or the bid user may be a player(s) of the game, but need not necessarily be the player(s). The listing user terminal 50 and/or the bid user terminal 70 may be a device(s) that make(s) it possible to play the game, but need not necessarily be the device(s) that make(s) it possible to play the game.

### (Hardware Configuration of Auction Server 10)

As illustrated in FIG. 1, the auction server 10 includes, for example, a processor 11, a memory 12, and a communication interface 13. These components are connected via a bus 19.

The processor 11 controls each section of the auction server 10 by executing a program stored in the memory 12. The processor 11 is constituted by, for example, an integrated circuit such as a central processing unit (CPU) or a graphics processing unit (GPU).

The memory 12 stores a program executed by the processor 11 and various types of data used by the processor 11. The memory 12 is constituted by, for example, a hard disk drive (HDD), a solid state drive (SSD), an electrically erasable programmable read-only memory (EEPROM (registered trademark)), a read only memory (ROM), a random access memory (RAM), or a combination of these. Note that part or all of the memory 12 not only may be incorporated in the auction server 10 but also may be externally attached via an input/output interface (not illustrated) such as a universal serial bus (USB). Alternatively, part or all of the memory 12 may be connected, as a device independent of the auction server 10, to the auction server 10 via a network.

The communication interface 13 is an interface connected to the network NW. The communication interface 13 is constituted by, for example, a wired connection interface such as Ethernet (registered trademark) or a wireless connection interface such as WiFi (registered trademark).

### (Hardware Configuration of Game Server 30)

As illustrated in FIG. 1, the game server 30 includes, for example, a processor 31, a memory 32, and a communication interface 33. These components are connected via a bus 39. Since the processor 31, the memory 32, and the communication interface 33 are described as in the case of the components included in the auction server 10 and having the same names, a detailed description thereof will be omitted.

### (Hardware Configuration of Listing User Terminal 50)

As illustrated in FIG. 1, the listing user terminal 50 includes, for example, a processor 51, a memory 52, a communication interface 53, an input device 54, and a display device 55. These components are connected via a bus 59.

Since the processor 51, the memory 52, and the communication interface 53 are described as in the case of the components included in the auction server 10 and having the same names, a detailed description thereof will be omitted. The input device 54 is a device that receives an operation by a user, and is constituted by, for example, a controller, a keyboard, a mouse, a touchpad, a microphone, a combination of these, or the like. The display device 55 is a device that displays a screen or the like pertaining to a transaction through an auction, and is constituted by, for example, a display. The input device 54 and/or the display device 55 not only may be incorporated in the listing user terminal 50 but also may be connected, as a peripheral device, to the outside.

### (Hardware Configuration of Bid User Terminal 70)

As illustrated in FIG. 1, the bid user terminal 70 includes, for example, a processor 71, a memory 72, a communication interface 73, an input device 74, and a display device 75. These components are connected via a bus 79. Since these components are described as in the case of the components included in the listing user terminal 50 and having the same names, a detailed description thereof will be omitted.

### (Configuration of Blockchain System 90)

The blockchain system 90 stores, in a plurality of distributed nodes (not illustrated) in a distributed manner, a blockchain, which is a column of blocks in which transaction data including, for example, an NFT associated with a listing medium and information pertaining to an owner of the listing medium are stored. The transaction data is generated in response to renewal of the owner of the listing medium and stored in the blockchain system 90. Details of information included in the transaction data will be described later.

The blockchain system 90 is realized by a blockchain technique known in the art. For example, the blockchain system 90 includes a plurality of distributed nodes. Each of the distributed nodes carries out mining for generating a block including transaction data to be newly stored. A block generated by a node that has succeeded in mining based on a prescribed consensus algorithm among a plurality of nodes is added, as a legitimate block, to a tail of the blockchain. A blockchain stored by each of the nodes is synchronized with the blockchain to which the legitimate block has been added. In a case where a blockchain branches, the longest blockchain is a legitimate blockchain. A blockchain to which a fraudulent block has been added is shorter than other blockchains and thus is overwritten by the legitimate blockchain.

### (Functional Configuration of Auction Server 10)

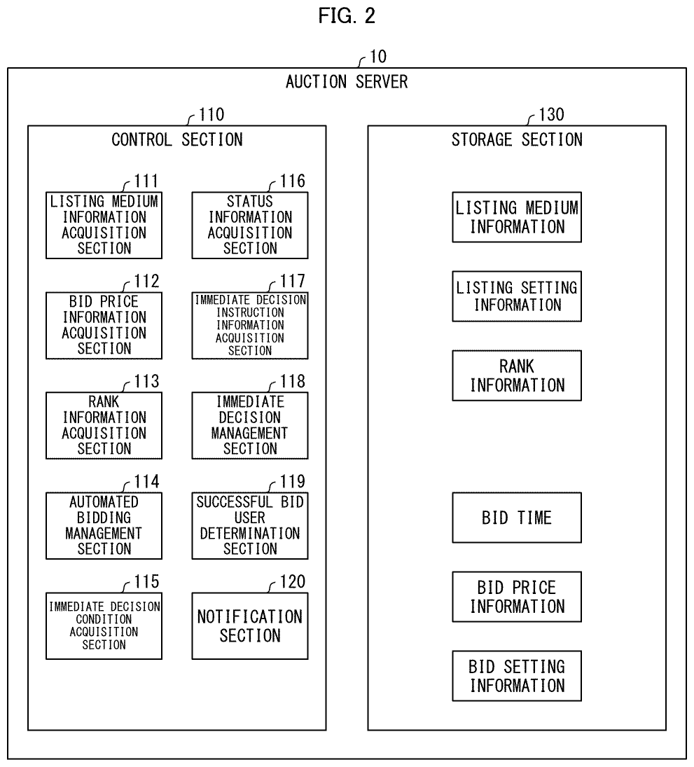

FIG. 2 is a block diagram illustrating a functional configuration of the auction server 10. As illustrated in FIG. 2, the auction server 10 includes a control section 110 and a storage section 130. The control section 110 is realized by the processor 11 executing a program stored in the memory 12. The storage section 130 is constituted by the memory 12.

The control section 110 includes a listing medium information acquisition section 111, a bid price information acquisition section 112, a rank information acquisition section 113, an automated bidding management section 114, an immediate decision condition acquisition section 115, a status information acquisition section 116, an immediate decision instruction information acquisition section 117, an immediate decision management section 118, a successful bid user determination section 119, and a notification section 120.

The listing medium information acquisition section 111 acquires, from a listing user who lists a listing medium which is listed in an auction, listing medium information indicating the listing medium. For example, the listing medium information acquisition section 111 acquires, from a listing user who lists a plurality of listing media which have an identical type and which are listed in one auction, listing medium information indicating the plurality of listing media. This makes it possible to carry out an auction of a medium, the acquisition of two or more of which is valuable, such as an electronic medium used in multiple units.

Note here that “one auction” refers to an auction that starts with listing carried out one time. For example, one auction may start with listing of one product, or may start by listing a plurality of products having an identical type. Further, after a product is listed, a product having an identical type may be added. Furthermore, one auction ends by satisfying a “termination condition” for terminating an auction. For example, in the present embodiment, one auction is identified by an auction ID (described later).

Note also that the “listing medium” refers to a medium which is listed in an auction. Examples of the medium include a product that can be actually used and an electronic medium that can be used in a virtual world, such as a game. Examples of the electronic medium include: game media that can be used in the game advanced by the game server 30, such as an item and a character; electronic information associated with an avatar in a virtual space in which communication with another person is carried out (information for changing an appearance of the avatar, information for changing sound, etc.); and media used in streaming of live performance in which a virtual space is used (an item for support or spirit-raising, a value for so-called tipping, etc.). With the electronic medium, a non-fungible token whose owner is managed in the blockchain system 90 may be associated. With this, in a case where the listing medium is an electronic medium, credibility of the electronic medium can be maintained. For example, it is possible to show that the electronic medium has not been generated by an inappropriate activity. Further, the non-fungible token being associated with the electronic medium makes it possible to easily acquire information pertaining to a transaction history.

An aspect of “listing media having an identical type” will be described. For example, in a case where a listing medium is an article that actually exists, due to, for example, circumstances such as an identical use and an identical product name, articles that are collectively listed, by a listing user in one auction, as listing media having an identical type are listing media having an identical type.

Another aspect of “listing media having an identical type” will be described. For example, in a case where the listing media are electronic media, electronic media with which identical medium identification information is associated are electronic media having an identical type. As yet another aspect, in a case where the listing media are media used in the game advanced by the game server 30, the listing media may be identical in function, capability, and property. In the case of this aspect, the listing media may be identical or different in appearance. Examples of such an aspect in which the listing media are different in appearance include media that are identical in, for example, function and are identical in outline of appearance, but are different only in color.

With each of individual electronic media included in the electronic media having an identical type, serial information for identifying each of the individual electronic media may be further associated, or the foregoing non-fungible token may be associated.

Further, information indicating a bid unit, which is a minimum quantity of listing media to be bid, may be associated with the listing medium information. This makes it possible to prevent a successful bid for listing media that are desirably used in the minimum quantity from being made with a number less than the minimum quantity. Furthermore, information indicating an upper limit number of listing media for which one successful bid user is able to successfully bid may be associated with the listing medium information. This allows a listing user to adjust the number of successful bidders.

The bid price information acquisition section 112 acquires bid price information indicating a bid price of a bid user who bids in the auction. For example, the bid price information acquisition section 112 may acquire the bid price information indicating the bid price of each of a plurality of bid users who bid in the auction. Further, a time at which a bid was made at the bid price indicated by the bid price information may be associated with the bid price information. The time at which a bid was made is hereinafter also referred to as a bid time.

Furthermore, bid quantity information indicating a bid quantity that has been specified by a bid user may be associated with the bid price information. This allows the bid user to bid for a desired quantity at one time. For example, for game media, etc. that are set to be advantageous by using a predetermined plurality thereof, a bid can be made for the predetermined plurality of the game media at one time. Note, however, that the bid quantity information need not necessarily be associated with the bid price information.

The rank information acquisition section 113 acquires rank information indicating a rank of the bid price information in descending order of the bid price. For example, the rank information indicates that, in a case where there are a plurality of pieces of the bid price information which pieces are identical in bid price, a piece of the bid price information which piece is earlier in bid time at which a bid was made at the bid price is in a higher rank. With this, in an auction in which a plurality of successful bid users appear, there is a case where a user who was able to make a successful bid and a user who was unable to make a successful bid appear despite the fact that those users are identical in bid price. In such a case, a degree of understanding of the user who was unable to make a successful bid is improved.

In a case where there are a plurality of pieces of the bid price information which pieces are identical in bid price, these pieces of the bid price information may be assigned not only the bid time but also a rank on the basis of other information. The other information may be, for example, a bid quantity. The bid quantity is the number of listing media for which a bid user wishes to make a successful bid, among pieces of information pertaining to a plurality of listing media that have an identical type and that are indicated by the listing medium information. For example, in a case where there are a plurality of pieces of the bid price information which pieces are identical in bid price, these pieces of the bid price information may be assigned ranks first in ascending order of the bid time. Next, in a case where there are a plurality of pieces of the bid price information which pieces are identical in bid price and bid time, those pieces of the bid price information may be assigned ranks in descending order of the bid quantity. Note, however, that a rank indicated by the rank information is not limited to these examples.

Until a termination condition under which a bidding period for the auction ends is satisfied, the automated bidding management section 114 (1) determines, on the basis of advance setting by the bid user who is associated with the bid price information, whether it is possible to update the bid price indicated by the bid price information whose rank is outside a successful bid range set on the basis of the number of listing media to a bid price for the rank to be within the successful bid range, and (2) updates the bid price in a case where the bid price is determined to be updatable. For example, the successful bid range set on the basis of the number of listing media is from rank 1 to a rank corresponding to the number of listing media. Further, for example, the bid price for the rank to be within the successful bid range may be a minimum bid price for the rank to be within the successful bid range.

This makes it possible to increase the possibility of making a successful bid, while reducing effort of a user to monitor a status of an auction. Further, more users can make a purchase at a minimum amount for being within the successful bid range or at an amount close to the minimum amount. This improves a sense of fairness. Assume, for example, that a bid price of another user who has bid most recently and who has come within the successful bid range is minimum in the successful bid range. In this case, in consideration of the purpose of entering the successful bid range, an aspect is also considered that is different from the present embodiment and such that re-bidding is automatically carried out at an amount obtained by adding, to the minimum bid price, a certain amount (for example, a minimum unit amount set in an auction for a bid). However, in the case of such an aspect, an amount at which re-bidding is carried out is not a minimum amount for coming within the successful bid range, and the minimum amount in the successful bid range increases at a high speed. Thus, a higher amount is necessary for a successful bid. In contrast, according to the above configuration of the present embodiment, since the amount at which re-bidding is carried out is the minimum amount for coming within the successful bid range, it is possible to prevent or reduce an increase in amount necessary for a successful bid. A larger number of listing media that are listed in one auction results in a greater effect of preventing or reducing an increase in amount necessary for a successful bid.

Further, for example, the advance setting by the bid user may include an upper limit of the bid price to be updated. The upper limit of the bid price to be updated is hereinafter also referred to as a “maximum bid price”. This makes it possible to prevent the bid user from making a bid at a higher amount than expected. Note, however, that the advance setting need not necessarily include the maximum bid price.

Note here that the “termination condition” is a condition under which the bidding period ends. Examples of the termination condition include expiration of a prescribed deadline set in advance as a bidding deadline (for example, passage of a prescribed time or time point) and a successful bid being made for a listing medium by a bid being made at a buyout price before expiration of the prescribed deadline (in the case of a plurality of listing media, a successful bid being made for the plurality of listing media). Further, in the case of one listing medium, a successful bid for the one listing medium may be the termination condition. Furthermore, for one auction, in an embodiment in which a plurality of listing media are listed, a successful bid being made for a product may be the termination condition. For example, in a case where a plurality of products are listed, a successful bid for the plurality of products may terminate the bidding period.

Further, “the minimum amount for being within the successful bid range” refers to a minimum amount among bid prices necessary for being within the successful bid range. For example, in a case where a bid price of another user who has bid most recently and who has come within the successful bid range is minimum in the successful bid range, the minimum amount for being within the successful bid range may be the same amount as the minimum bid price. Furthermore, for example, in a case where the same amount makes it impossible to come within the successful bid range, the minimum amount for being within the successful bid range may be an amount obtained by adding, to the same amount, a minimum unit amount set in advance.

Note, however, that the updated bid price is not limited to “the minimum amount for being within the successful bid range”, and may be an amount higher than the minimum amount. For example, the amount higher than the minimum amount may be, for example, a bid price in a given rank in ascending order (for example, the second lowest bid price) in the successful bid range, but is not limited to this.

The immediate decision condition acquisition section 115 acquires immediate decision condition information indicating an immediate decision condition for determining a successful bid user who successfully bids for the listing medium before a deadline set in advance as a bidding deadline for the auction expires. The immediate decision condition may be, for example, that the bid price is a buyout price set in advance. In this case, a bid exceeding the buyout price may be impossible.

The status information acquisition section 116 acquires status information indicating a status of the auction. The status information is information indicating a status that changes due to the progress of an auction. Examples of the status information include: (1) in the case of a plurality of listing media, the remaining number of listing media for which a successful bid has not yet been made; (2) a bid price by another bid user; (3) the number of bid users who participate in the auction; (4) remaining time of the auction; and (5) the number of bids.

For example, the status information may include information indicating a remaining number obtained by subtracting, from the number of the plurality of listing media that have an identical type and that are indicated by the listing medium information, the number of listing media for which a successful bid has been made. Further, for example, the status information may include information indicating a bid price of another bid user. Furthermore, for example, the status information may include information indicating the number of bid users who bid in the auction. Moreover, for example, the status information may include information indicating remaining time until a deadline set in advance expires. Note that the status information is not limited to the foregoing information and may include information indicating another status which changes due to the progress of the auction. For example, the status information may include information indicating a successful bid user determined by an immediate decision described later. For example, a bid user who wishes to acquire the same listing medium as a specific user may set, as immediate decision instruction information described later, the following immediate decision instruction information: “in a case where a successful bid user indicated by the status information is the specific user, a bid which satisfies the immediate decision condition is executed”.

The immediate decision instruction information acquisition section 117 acquires immediate decision instruction information indicating an immediate decision instruction to, in a case where the status information has specific content set in advance, execute a bid which satisfies the immediate decision condition. Note here that the “immediate decision instruction information” is information indicating an instruction to, in a case where the status information has specific content set in advance, execute a bid which satisfies the immediate decision condition. For example, in a case where a buyout price has been specified as the immediate decision condition, the immediate decision instruction includes an instruction to make a bid at the buyout price, an instruction to make a bid at the buyout price or higher, and an instruction to, without including a specific buyout price in content of the instruction, make a bid which satisfies the immediate decision condition. For example, in a case where the buyout price is 10,000 yen, the instruction includes an instruction to execute a bid at 10, 000 yen, an instruction to execute a bid at an amount higher than 10,000 yen, and an instruction to, without including, in content of the instruction, information indicating an amount of 10,000 yen, execute a bid which satisfies the buyout price.

Examples of the status information having the specific content include: (1) a condition that, in the case of a plurality of listing media, the remaining number of listing media for which a successful bid has not yet been made reaches a prescribed number or less; (2) a condition that a bid price by another bid user is not less than a prescribed amount; (3) a condition that the number of bid users who participate in the auction is not less than a prescribed number; (4) a condition that remaining time of the auction is not more than a prescribed time; and (5) a condition that the number of bids is not less than a prescribed number. One of these conditions may be used alone, or two or more of these conditions may be used in combination.

For example, the immediate decision instruction information may be information indicating an instruction to, in a case where the remaining number indicated by the information included in the status information is not more than a prescribed number, execute the bid which satisfies the immediate decision condition. By setting such immediate decision instruction information, for one auction in which a plurality of listing media having an identical type are listed, a bid user can make a successful bid by an immediate decision before a successful bid is made for all the listing media. It is also possible to reduce an immediate decision that is made by the bid user at an unnecessarily high price.

Further, for example, the immediate decision instruction information may be information indicating an instruction to, in a case where the foregoing bid price of the another bid user which bid price is indicated by the information included in the status information is not less than a prescribed amount, execute the bid which satisfies the immediate decision condition. More bids made by other bid users result in a higher bid price. This makes it highly likely for the bid price to reach a buyout price. According to the present configuration, an immediate decision can be made before a bid price by another bid user reaches a buyout price.

Further, for example, the immediate decision instruction information may be information indicating an instruction to, in a case where the foregoing number of bid users which number is indicated by the information included in the status information is not less than a prescribed number, execute the bid which satisfies the immediate decision condition. An increase in number of other bid users makes it highly likely to prevent a successful bid from being made. According to the present configuration, an immediate decision can be made also in such a case.

Further, for example, the immediate decision instruction information may be information indicating an instruction to, in a case where the foregoing remaining time indicated by the information included in the status information is not more than a prescribed time, execute the bid which satisfies the immediate decision condition. Setting such immediate decision instruction information allows a bid user to make an immediate decision with a margin in the remaining time. For example, in a case where the remaining time is short, a risk occurs that an instruction for an immediate decision is not reflected due to, for example, server congestion. However, the present configuration makes it possible to reduce such a risk.

Note that the immediate decision instruction information may be information including, as a condition for executing the bid which satisfies the immediate decision condition, not only the conditions described earlier but also a condition pertaining to any information included in the status information. In a case where the status information has

the specific content set in advance, the immediate decision management section 118 executes, on the basis of the immediate decision instruction information, the bid which satisfies the immediate decision condition. This makes it possible to provide a bid user with a system that enables an immediate decision in accordance with a status of an auction. For example, it is possible to reduce an immediate decision that is made by the bid user at an unnecessarily high price. Further, the bid user can make an immediate decision with a margin with respect to an auction end time without managing the auction end time.

The successful bid user determination section 119 determines, among a plurality of bid users, a plurality of successful bid users who successfully bid for at least some of the plurality of listing media that have an identical type and that are indicated by the listing medium information. Further, the successful bid user determination section 119 may determine a successful bid user so that the number of listing media for which the same successful bid user successfully bids, among the plurality of listing media that have an identical type and that are indicated by the listing medium information is not more than an upper limit number. Furthermore, on the basis of the bid which has been executed by the immediate decision management section 118 and which satisfies the immediate decision condition, the successful bid user determination section 119 determines, as a successful bid user who successfully bids for a listing medium, a bid user who is associated with the immediate decision instruction information. Determining the successful bid user by the bid which satisfies the immediate decision condition is hereinafter also referred to as “making an immediate decision”.

The notification section 120 provides a bid user who is associated with the bid price information whose rank is lower than the successful bid range with notification that the bid user is outside the successful bid range. This allows the bid user who has fallen outside the successful bid range to know this fact. Note, however, that notification by the notification section 120 need not necessarily be carried out. Further, the notification section 120 may notify the bid user of a successful bid result indicating whether the bid user has been determined as a successful bid user. Furthermore, after the end of the auction, the notification section 120 may notify a listing user of the successful bid result including the successful bid user who has successfully bid for a listing medium. Moreover, after the end of the auction, in a case where the listing medium is a game medium, the notification section 120 may notify the game server 30, after the end of the auction, of the successful bid result including the fact that an owner of the listing medium has been changed from the listing user to the bid user. In addition, after the end of the auction, in a case where an NFT is associated with the listing medium, the notification section 120 may notify the blockchain system 90 of the successful bid result including the fact that the owner of the listing medium has been changed from the listing user to the bid user.

### (Information Stored in Auction Server 10)

As illustrated in FIG. 2, the storage section 130 stores the listing medium information, listing setting information, the rank information, the bid time, the bid price information, and bid setting information. The listing medium information is information that is acquired by the listing medium information storage section and that includes information indicating a listing medium and the number of listings of the listing medium. The listing setting information is information that is acquired by the listing medium information acquisition section 111 in association with the listing medium information and that indicates advance setting by the listing user. For example, the listing setting information may include the bidding deadline, the immediate decision condition, the information indicating a bid unit, and information indicating an upper limit number. The rank information is information that is acquired by the rank information acquisition section 113. The listing medium information, the listing setting information, and the rank information are stored in association with each other for each auction. In a case where a plurality of auctions are proceeding in parallel, a plurality of sets of the listing medium information, the listing setting information, and the rank information are stored in the storage section 130.

The bid price information is information that is acquired by the bid price information acquisition section 112. The bid time indicates a time at which the bid price indicated by the bid price information is updated. The bid setting information is information that is acquired by the bid price information acquisition section 112 in association with the bid price information and that indicates the advance setting by the bid user. The bid setting information includes information indicating whether to automatically update the bid price for the listing medium. Automatically updating the bid price is hereinafter also referred to as automated bidding. Further, not automatically updating the bid price is hereinafter also referred to as manual bidding. In other words, the bid setting information includes information indicating whether to carry out automated bidding. Furthermore, for example, the bid setting information may include information indicating the maximum bid price, the bid quantity, yes or no of purchase of some of the bid quantity, yes or no of notification of “out-of-successful bid range”, etc. Moreover, the bid setting information may include the immediate decision instruction information. The bid price information and the bid setting information are stored in association with each other for each bid. In a case where a plurality of bids are made for one auction, a plurality of sets of the bid time, the bid price information, and the bid setting information are stored in the storage section 130 in association with the one auction.

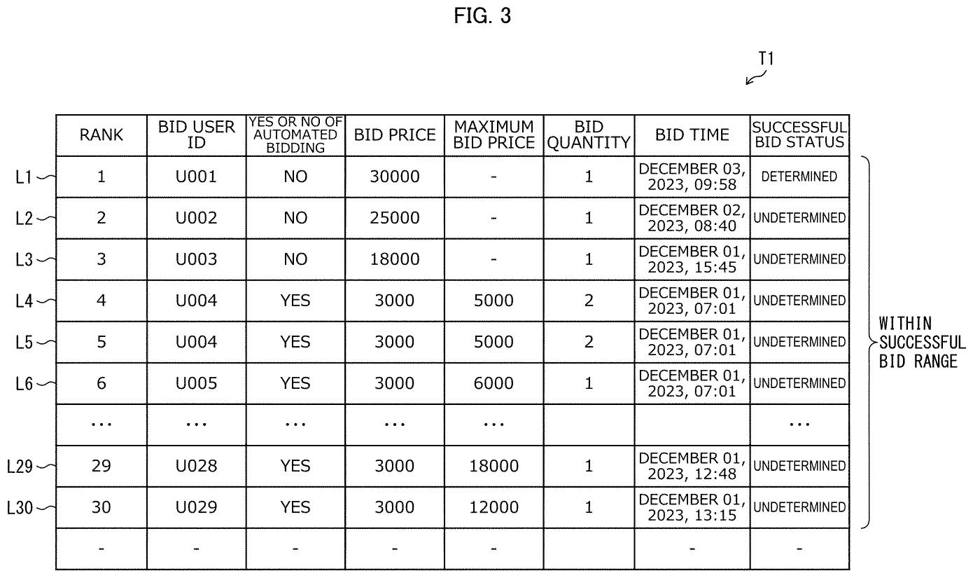

An example of the rank information is described here with reference to FIG. 3. FIG. 3 is a diagram illustrating an example of the rank information. In FIG. 3, a table T1 shows rank information at a certain time point which rank information is associated with certain listing medium information. In the table T1, a bid made by at least one bid user for the auction is generated as a record of one line for each bid unit. In this example, the bid unit is 1. The table T1 can be updated during the bidding period. For example, the table T1 is updated in accordance with a new bid being made, the bid price being updated in an existing bid, the bid setting information being updated, and/or the like. The table T1 includes records L1 to L30 and shows that a bid of 30 units has been made by this time point. Further, in this example, the number of listing media is 30, and up to rank 30 is within the successful bid range. At the time point shown in FIG. 3, there is no record outside the successful bid range.

Further, each of the records in the table T1 includes items, which are a rank, a bid user ID, yes or no of automated bidding, a bid price, a maximum bid price, a bid quantity, a bid time, and a successful bid status. The rank of each of the records is a rank assigned on the basis of at least the bid price. In this example, the records L1 to L30 are assigned rank 1 to 30 in descending order of the bid price. Further, a plurality of bids (e.g., records L4 to L30) that are identical in bid price are assigned ranks (e.g., rank 4 to 30) in ascending order of the bid time. Furthermore, a plurality of bids (e.g., records L4 to L6) that are identical in bid price and bid time are assigned ranks (e.g., rank 4 to 6) in descending order of the bid quantity.

Moreover, in each of the records, the bid user ID is information for identifying a bid user who has made a bid indicated by a corresponding record. A bid user whose bid user ID is “U001” is also referred to as, for example, a bid user U001. The records L1 to L3 and L6 to L30 indicate bids made by respective different bid users U001 to U003 and U005 to U028 assuming that the bid quantity is 1. The records L4 and L5 indicate bids made by the same bid user U004 assuming that the bid quantity is 2.

Yes or no of automated bidding indicates whether to carry out automated bidding for a bid indicated by a corresponding record. Yes or no of automated bidding is information selected by the bid user. The bid price indicates the bid price at the present time. In a case where yes or no of automated bidding is “yes”, an initial value of the bid price may be a minimum bid price set by a listing user, and can be updated by the automated bidding management section 114. Further, in a case where yes or no of automated bidding is “no”, the initial value of the bid price is an amount input by the bid user, and can be updated by input by the bid user. The maximum bid price is an upper limit amount set by the bid user in a case where yes or no of automated bidding is “yes”, and is not set in a case where yes or no of automated bidding is “no”. The bid quantity indicates a quantity of bids made. In a case where a plurality of bids have been made, the bid quantity is the number of the plurality of bids (2 in this example) in each of the records (e.g., records L4 and L5), the number of which corresponds to the number of the plurality of bids. The bid time is a time at which a bid has been made. In a case where the bid price is updated, the bid time is updated to a time at which the bid price is updated. Note that yes or no of automated bidding, the maximum bid price, and the bid quantity may be changeable after the bid on the basis of an operation by the bid user.

The successful bid status is information indicating a status of a successful bid, and indicates “determined” or “undetermined” until the bidding period ends. After the end of the bidding period, the successful bid status indicates “determined” or “failed”. A record in which the successful bid status is determined before the bidding period ends indicates that an immediate decision has been made.

In this example, the record L1 indicates a bid which has been made through manual bidding and which satisfies a buyout price. In the record L1, a successful bid has been determined (immediately decided) before the end of the bidding period. The records L2 and L3 each indicate a bid which has been made through manual bidding and the price of which is less than the buyout price. Records L4 to L31 each indicate a bid which has been made through automated bidding, and a minimum bid price (described later) is applied as the initial value of the bid price.

### (Functional Configuration of Game Server 30)

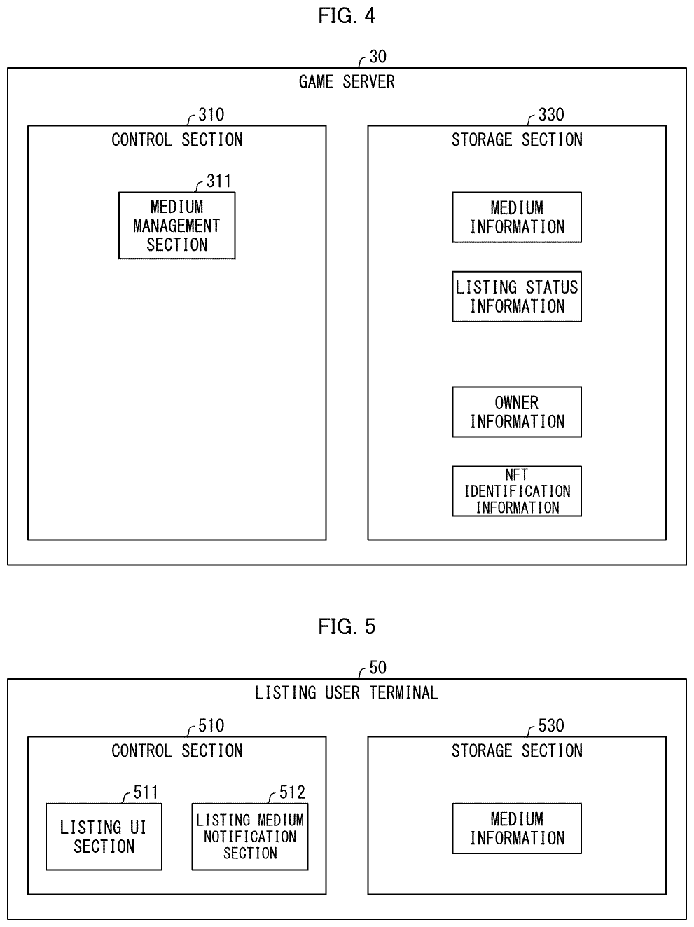

FIG. 4 is a block diagram illustrating a functional configuration of the game server 30. As illustrated in FIG. 4, the game server 30 includes a control section 310 and a storage section 330. The control section 310 is realized by the processor 31 executing a program stored in the memory 32. The storage section 330 is constituted by the memory 32. The control section 310 includes a medium management section 311.

The storage section 330 stores medium information, listing status information, owner information, and NFT identification information. The number of pieces of the medium information stored in the storage section 330 is one or more. The medium information indicates a game medium used in the game advanced by the game server 30. Further, the listing status information is associated with each piece of the medium information. The listing status information indicates whether the game medium indicated by the medium information is being listed in an auction. In an initial state, the listing status information indicates that the game medium is not being listed.

Further, the owner information indicating an owner of the game medium indicated by the medium information is associated with each piece of the medium information. Note that there is a case where the owner of the game medium indicated by the medium information is absent. For example, an owner of a game medium to be newly sold by a management side has not yet been present. The owner information indicating that there is no owner may be associated with the medium information indicating such a game medium. Further, in a case where the owner of the game medium indicated by the medium information is managed by the blockchain system 90, identification information for an NFT is associated with the medium information. Furthermore, in this case, the owner information associated with the medium information is configured to be synchronized with the owner information associated with the identification information for the NFT in the blockchain system 90.

The medium management section 311 which has been notified that a game medium has been listed updates the listing status information, which is associated with the medium information indicating the game medium, so as to indicate that the game medium is being listed in an auction. Note that the following description will discuss an embodiment in which “the game medium having been listed” is notified by the listing user terminal 50. Note, however, that “the game medium having been listed” may be notified by not only the listing user terminal 50 but also the auction server 10. Further, the medium management section 311 which has been notified by the auction server 10 that a successful bid has been made for a game medium updates the listing status information, which is associated with the medium information indicating the game medium, so as to indicate that the game medium is not being listed. Furthermore, the medium management section 311 refers to the listing status information and makes it impossible to use, in a game, a game medium that is being listed. Moreover, in a case where a game medium is not being listed (including a case where a successful bid has been made for the game medium), the medium management section 311 makes it possible to use the game medium in the game.

### (Functional Configuration of Listing User Terminal 50)

FIG. 5 is a block diagram illustrating a functional configuration of the listing user terminal 50. As illustrated in FIG. 5, the listing user terminal 50 includes a control section 510 and a storage section 530. The control section 510 is realized by the processor 51 executing a program stored in the memory 52. The storage section 530 is constituted by the memory 52.

The control section 510 includes a listing UI section 511 and a listing medium notification section 512. The listing UI section 511 provides a listing user with a user interface for listing a listing medium. In a case where the listing medium is a game medium, the listing medium notification section 512 notifies the game server 30 of a listing status of the game medium. The storage section 530 stores the medium information representing a medium that the listing user can list in an auction. For example, the medium that the listing user can list in the auction may be, for example, a game medium owned by the listing user.

Further, in a case where the listing user is an operator on a management side of a game, the medium that the listing user can list in the auction may be a game medium, the owner of which has not yet been present and which is to be newly sold from the management side. In this case, the listing user terminal 50 may be a terminal that functions as a management terminal of the game server 30.

### (Functional Configuration of Bid User Terminal 70)

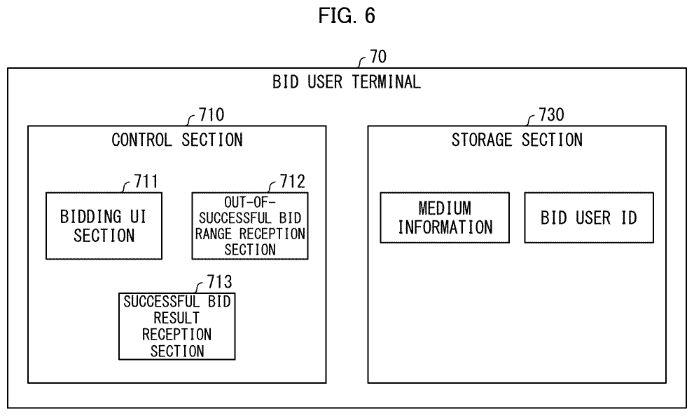

FIG. 6 is a block diagram illustrating a functional configuration of the bid user terminal 70. As illustrated in FIG. 6, the bid user terminal 70 includes a control section 710 and a storage section 730. The control section 710 is realized by the processor 71 executing a program stored in the memory 72. The storage section 730 is constituted by the memory 72.

The control section 710 includes a bidding UI section 711, an out-of-successful bid range reception section 712, and a successful bid result reception section 713. The bidding UI section 711 provides a bid user with a user interface for making a bid in an auction. The out-of-successful bid range reception section 712 which has received, from the auction server 10, information indicating “out-of-successful bid range” outputs the received information in a manner recognizable to the bid user. The successful bid result reception section 713 receives, from the auction server 10, a successful bid result of the auction in which the bid has been made, and outputs the received successful bid result in a manner recognizable to the bid user. Examples of output in a manner recognizable to the bid user include display on the display device 75, sound output to a sound output device (not illustrated), and a combination of these. Further, in a case where the successful bid result indicates that a successful bid has been made, the successful bid result reception section 713 stores, in the storage section 730, the medium information indicating a listing medium for which a successful bid has been made. The storage section 730 stores the medium information indicating a medium that is owned by the bid user and a bid user ID that identifies the bid user. The medium that is owned by the bid user includes a medium for which a successful bid has been made in the auction. Further, for example, the medium that is owned by the bid user may include a game medium that is owned by the bid user.

### <Process Carried Out by System 1>

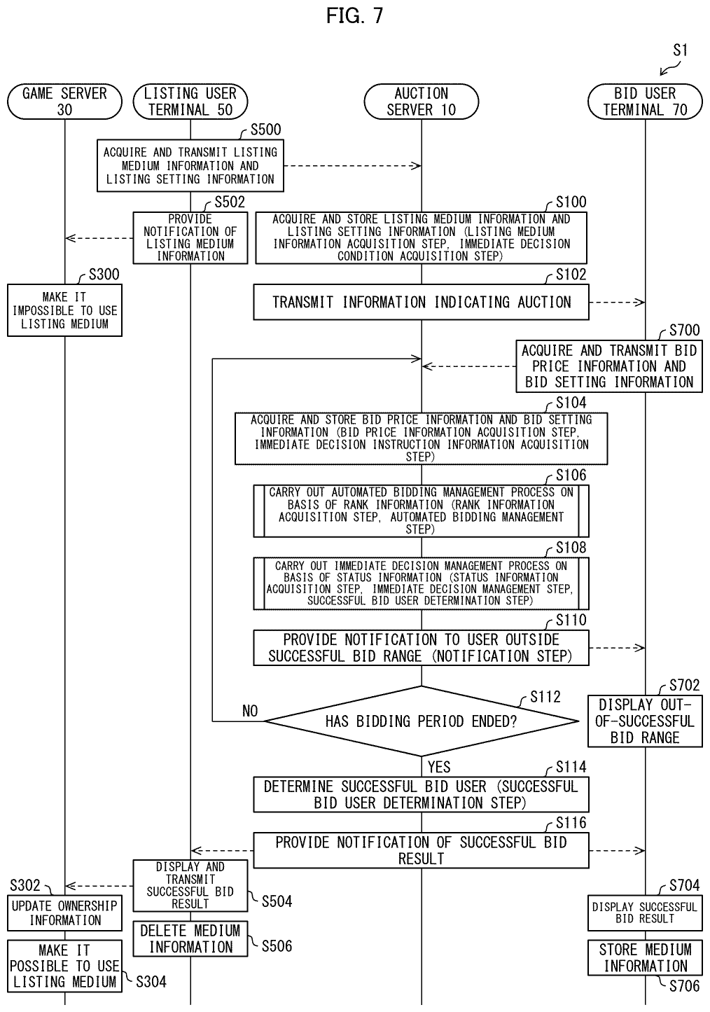

The system 1 configured as described above carries out an information processing method S1. FIG. 7 is a diagram illustrating a flow of the information processing method S1. In the following description of the information processing method S1, an example will be mainly discussed in which the game medium used in the game advanced by the game server 30 is applied as the listing medium. Further, an example will be mainly discussed in which the listing user is the operator on the management side of the game advanced by the game server 30. Furthermore, an example will be mainly discussed in which the management side uses the system 1 to newly sell a plurality of game media having an identical type.

As illustrated in FIG. 7, the information processing method S1 includes: a process for listing a game medium (steps S500 to S506); a process for managing the listed game medium (S300 to S304); a process for using an auction to make a transaction for the listed game medium (S100 to S116); and a process for bidding in the auction (S700 to S706).

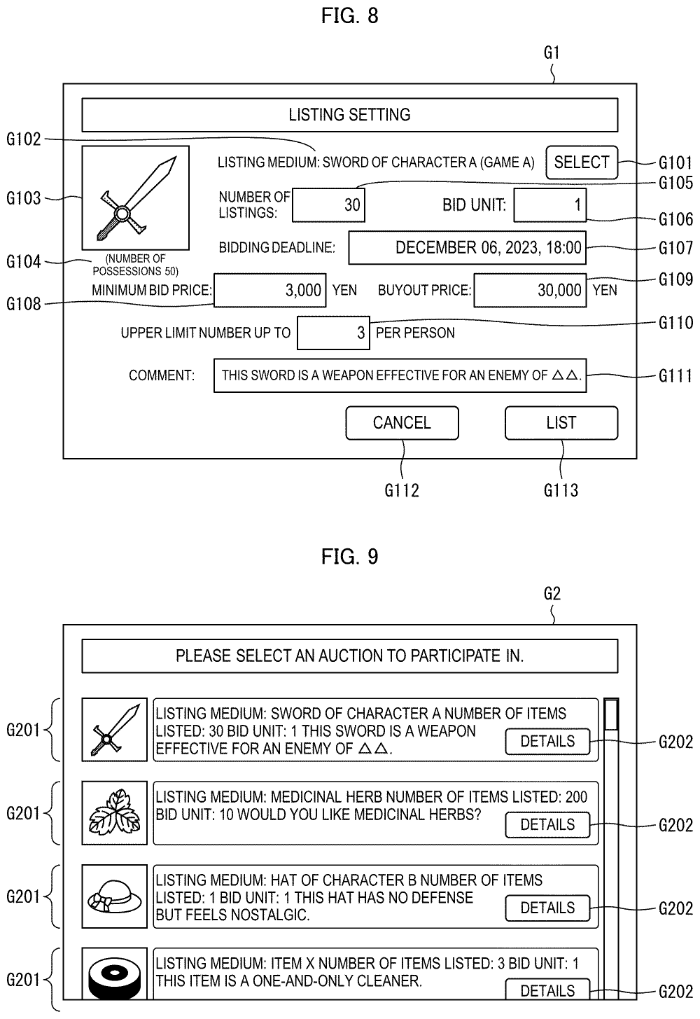

In step S500, the listing UI section 511 of the listing user terminal 50 acquires the listing medium information and the listing setting information on the basis of an operation by the listing user. Further, the listing UI section 511 transmits the acquired listing medium information and the acquired listing setting information to the auction server 10. FIG. 8 is an example screen G1 displayed on the display device 55 of the listing user terminal 50 in the step. In the example screen G1, a user interface (hereinafter referred to as “UI”) object G101 receives an operation for selecting a listing medium to be listed in an auction. For example, upon reception of an operation on the UI object G101, a list (not illustrated) of media indicated by the medium information stored in the storage section 530 may be displayed, and a medium specified on the basis of an operation on the list may be selected as the listing medium. Information G102 and an image G103 each indicate the selected listing medium. In this example, as the listing medium, a game medium named “sword of character A” that can be used in a game A is selected. The game A is, for example, a type of the game advanced by the game server 30. Information G104 indicates the number of selected listing media owned by the listing user. In this example, the listing user owns 50 game media named “sword of character A”.

A UI object G105 receives an operation for inputting the number of listings of the listing medium selected by the UI object G101. In this example, 30 among the 50 owned game media named “sword of character A” are listed in the auction. Information that is input by operating the UI objects G101 and G105 and that indicates the listing medium and the number of listings constitutes, for example, the listing medium information.

A UI object G106 receives an operation for inputting a bid unit. In this example, the bid unit is “1”. In other words, the bid user may bid for only one of the 30 listing media named “sword of character A” or may make a plurality of bids per medium.

A UI object G107 receives an operation for inputting a bidding deadline. In this example, an input bidding deadline “Dec. 6, 2023, 18:00” is a time point at which a bidding period ends at latest. Note, however, as described earlier, the bidding period may end before the input bidding deadline expires. For example, in a case where the remaining number of listing media reaches zero due to an immediate decision before the bidding deadline expires, the bidding period ends at that time point. The bidding period may start at a time point at which an operation for instructing listing (e.g., an operation on a UI object G113) is carried out. Note that, instead of receiving an operation for inputting the bidding deadline, the UI object G104 may receive an operation for inputting a length (such as three days) from the time point at which the bidding period starts.

A UI object G108 receives an operation for inputting a minimum bid price. In manual bidding, it is impossible to make a bid at an amount lower than the minimum bid price. Further, in automated bidding, the minimum bid price is applied as an initial value of a bid price. Note that the minimum bid price need not necessarily be input. In a case where the operation for instructing listing is carried out without input of the minimum bid price, for example, the process may be carried out with a prescribed amount (e.g., 1 yen or the like) regarded as the minimum bid price.

A UI object G109 receives an operation for inputting a buyout price. The buyout price is an example of the immediate decision condition and indicates a bid price for immediately deciding a successful bid user who successfully bids for the listing medium before the bidding period ends. In this example, a user who has made a bid at a buyout price of “30,000 yen” is immediately decided as a successful bid user. The buyout price need not necessarily be input. Note, however, that, in a case where the buyout price is input, it is impossible to make a bid at a bid price exceeding the buyout price.

A UI object G110 receives an operation for inputting an upper limit number of listing media for which one successful bid user is able to successfully bid. The upper limit number need not necessarily be input. In a case where the operation for instructing listing is carried out without input of the upper limit number, for example, the process may be carried out with the number of listings regarded as the upper limit number.

A UI object G111 receives an operation for inputting a comment for the listing medium. Information input by operating the UI objects G106 to G111 constitutes, for example, the listing setting information.

A UI object G112 receives an operation for canceling listing based on the example screen G1. A UI object G113 receives an operation for listing a listing medium in accordance with input content in the example screen G1. Upon reception of an operation on the UI object G113, the listing UI section 511 transmits, to the auction server 10, the listing medium information input by UI objects G101 and G105 and the listing setting information input by the UI objects G106 to G111.

FIG. 7 is referred to again to describe the flow of the information processing method S1 on and after step S502. In step S502, the listing medium notification section 512 also notifies the game server 30 of the listing medium information transmitted to the auction server 10.

In step S300, upon receiving the listing medium information from the listing user terminal 50, for each of game media, the number of listings of which is indicated by the listing medium information, the medium management section 311 of the game server 30 updates the listing status information, which is associated with the medium information indicating the game media, so as to indicate that the game media are being listed. With this, the medium management section 311 makes it impossible to use the game media of this number of listings in the game.

In step S100 (a listing medium information acquisition step and an immediate decision condition acquisition step), the listing medium information acquisition section 111 of the auction server 10 receives the listing medium information and the listing setting information from the listing user terminal 50. In this example, the listing medium information indicates a plurality of listing media having an identical type. Further, in a case where the listing setting information includes the immediate decision condition information, the immediate decision condition acquisition section 115 acquires the immediate decision condition information. The listing setting information sometimes includes information indicating the bid unit. Furthermore, the listing setting information sometimes includes information indicating the upper limit number. Moreover, the listing medium information acquisition section 111 issues the auction ID that identifies an auction, and stores the auction ID, the listing medium information, and the listing setting information in the storage section 130 in association with each other.

In step S102, the control section 110 transmits, to the bid user terminal 70, information indicating at least one auction. The information indicating the auction is generated on the basis of the listing medium information and the listing setting information that are stored in the storage section 130. For example, in response to a request from the bid user terminal 70, the control section 110 may transmit the information indicating the at least one auction.

In step S700, the bidding UI section 711 of the bid user terminal 70 displays the received information indicating the auction, and acquires, on the basis of the operation by the bid user, the bid price information and the bid setting information for any of the at least one auction. Further, the bidding UI section 711 transmits, to the auction server 10, the acquired bid price information, the acquired bid setting information, and the bid user ID stored in the storage section 730. FIGS. 9 to 11 are diagrams illustrating example screens G2 to G4 displayed on the display device 75 of the bid user terminal 70 in the step.

The example screen G2 illustrated in FIG. 9 includes information G201 that shows a list of auctions and that indicates each of at least one auction which is being held. The information G201 indicates information pertaining to one auction and includes information indicating a listing medium, the number of listings, a bid unit, and a comment. Note that the information G201 may include not only the example illustrated in FIG. 9 but also information based on the listing setting information stored in the storage section 130 of the auction server 10 (e.g., the bidding deadline, the immediate decision condition, etc.). The information G201 may also include the status information that is acquired by the status information acquisition section 116 and that indicates a status of the auction (e.g., the current minimum bid price for successful bidding, the current number of bid users, etc.). The information G201 may also include information indicating a listing user (e.g., a name of the listing user). Further, the UI object G202 is disposed in correspondence with each piece of the information G201. Upon reception of an operation on the UI object G202, an auction indicated by a corresponding piece of the information G201 is considered to have been selected, and the example screen G2 transitions to an automated bidding selection screen (not illustrated) for selecting whether to carry out automated bidding.

In a case where automated bidding is not selected on the automated bidding selection screen, the automated bidding selection screen transitions to a manual bidding screen (not illustrated) for inputting a bid price in manual bidding. Further, the bidding UI section 711 transmits, to the auction server 10, the bid price information including the bid price input on the manual bidding screen, the bid setting information including no automated bidding, and the bid user ID stored in the storage section 730.

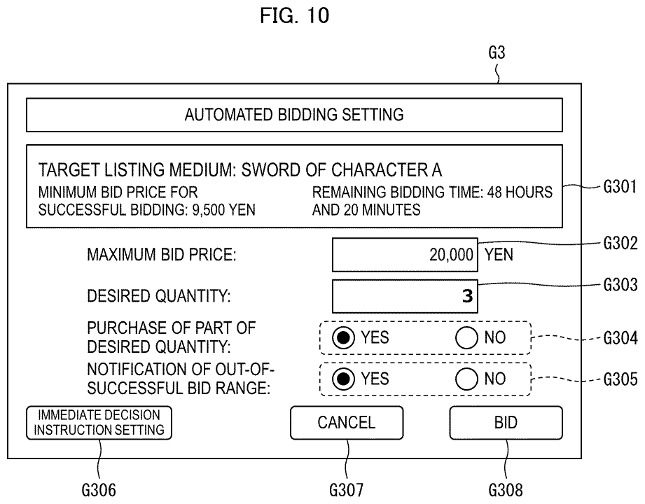

Furthermore, in a case where automated bidding is selected on the automatic update selection screen, the automatic update selection screen transitions to the example screen G3 in which a setting related to automated bidding is carried out. In the example screen G3 illustrated in FIG. 10, information G301 indicates detailed information pertaining to the auction. This example shows that a target listing medium is “sword of character A”, the minimum bid price for successful bidding is “9,500 yen”, and remaining bidding time is “48 hours and 20 minutes”. The minimum bid price for successful bidding indicates a minimum amount for being within the successful bid range at the present time in the auction, and is calculated in accordance with the rank information at the present time. Note that the present time is a time point at which the example screen G3 is displayed. The remaining bidding time indicates a length of a period from the present time to the bidding deadline. In this example, the remaining bidding time indicates a period up to the bidding deadline input by the listing user in the example screen G1.

A UI object G302 receives an operation for inputting the maximum bid price for the auction. In this example, a bid up to the maximum bid price of “20,000 yen” is automatically made for the auction.

A UI object G303 receives an operation for inputting a desired quantity (bid quantity) for which a bid user desires to successfully bid, among a plurality of listing media in the auction that have an identical type. In this example, a desire to successfully bid for three of the 30 listing media named “sword of character A” is input. In a case where the bid unit is input by the listing user in the example screen G1, the UI object G303 receives only a multiple of the bid unit as the desired quantity. For example, in a case where the bid unit is 2, a multiple of 2, such as 2, 4, . . . is received as the desired quantity, but a number that is not a multiple of 2, such as 3, 5, etc. is not received. Further, in a case where the upper limit number is input by the listing user in the example screen G1, the UI object G303 receives only a number not more than the upper limit number as the desired quantity. For example, in a case where the upper limit number is 10, a number not more than 10 is received as the desired quantity, and a number more than 10 is not received even if the number of listings is 30. In a case where a plurality of numbers are input as the desired quantity, the foregoing maximum bid price indicates the maximum bid price per number.

A UI object G304 receives an operation for selecting whether to make a successful bid with a quantity smaller than the desired quantity. For example, in the rank information after the end of the bidding period, only a part of the desired quantity can be in the successful bid range. Assume, for example, that “yes” is selected in the UI object G304. In this case, when the desired quantity is three and one is within the successful bid range, a successful bid is made for only the one. Further, assume, for example, that “no” is selected in the UI object G304. In this case, when the desired quantity is three and one is within the successful bid range, a successful bid is not made for any of the three.

A UI object G305 receives an operation for selecting whether to receive notification of “out-of-successful bid range”. The notification of “out-of-successful bid range” may be provided on the basis of a timing at which “within-successful bid range” changes to “out-of-successful bid range”, or may be provided at prescribed intervals.

A UI object G306 receives an operation for setting the immediate decision instruction information. Upon reception of the operation on the UI object G306, the example screen G3 transitions to an example screen G4 for setting the immediate decision instruction information. Information input in the example screen G3 is temporarily stored in the storage section 730.

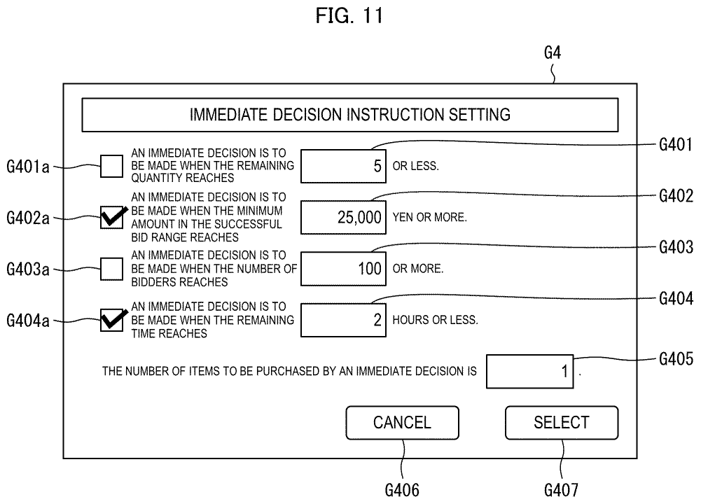

In the example screen G4 illustrated in FIG. 11, UI objects G401 to G404 receive an operation for inputting information that can be an immediate decision instruction. Further, the UI objects G401a to G404a respectively receive an operation for selecting whether to set, as the immediate decision instruction information, information input by the UI objects G401 to G404. In this example, information indicating that a bid which satisfies a buyout price is instructed to be made in a case where the remaining number for which a successful bid has not been made is not more than 5 is input by an operation on the UI object G401. Further, information indicating that the bid which satisfies the buyout price is instructed to be made in a case where a minimum amount in the successful bid range is not less than 25,000 yen is input by an operation on the UI object G402. Furthermore, information indicating that the bid which satisfies the buyout price is instructed to be made in a case where the number of bid users is not less than 100 is input by an operation on the UI object G403. Moreover, information indicating that the bid which satisfies the buyout price is instructed to be made in a case where the remaining time is not more than 2 hours is input by an operation on the UI object G404. In addition, since the UI objects G402a and G404a are selected among the UI objects G401a to G404a, information input by the UI objects G402 and G404 is set as the immediate decision instruction information.

A UI object G405 receives an operation for inputting an immediate decision quantity that instructs the bid which satisfies the buyout price to be made in a case where a condition indicated by the immediate decision instruction information is satisfied. In this example, input of a number not less than 1 and not more than a desired quantity is received as the immediate decision quantity. For example, the bid user can enhance reliability of successful bidding by setting the desired quantity to two or more and allowing a bid for at least a part of the desired quantity to be made at a buyout price.

An UI object G406 receives an operation for canceling a setting based on the example screen G4. A UI object G407 receives an operation for determining the immediate decision instruction information in accordance with input content in the example screen G4. Upon reception of the operation on the UI object G407, the example screen G4 transitions to the example screen G3. Information input in the example screen G4 constitutes an example of the immediate decision instruction information and is temporarily stored in the storage section 730.

In the example screen G3 illustrated in FIG. 10, a UI object G307 receives an operation for canceling a setting based on the example screen G3. A UI object G308 receives an operation for bidding in the auction. Upon reception of the operation on the UI object G308, the bidding UI section 711 transmits, to the auction server 10, the bid price information and the bid setting information, which have been input in the example screens G3 and G4, the bid user ID stored in the storage section 730, and the bid time. The bid setting information includes the immediate decision instruction information input in the example screen G4. Note, however, that the immediate decision instruction information need not necessarily be input, and the bid setting information need not include the immediate decision instruction information. The bid time may be, for example, a time at which the bid price information and the bid setting information are transmitted, but is not limited to this.

FIG. 7 is referred to again to continuously describe the flow of the information processing method S1 on and after step S104. In step S104 (a bid price information acquisition step and an immediate decision execution instruction information acquisition step), the bid price information acquisition section 112 of the auction server 10 receives the bid price information and the bid setting information from the bid user terminal 70. Further, during the bidding period, the bid price information acquisition section 112 may receive the bid price information, the bid setting information, and the bid user ID from a respective plurality of bid user terminals 70. Furthermore, in a case where the bid setting information includes the immediate decision execution instruction information, the immediate decision instruction information acquisition section 117 acquires the immediate decision execution instruction information. Moreover, the bid price information acquisition section 112 stores the received bid price information, the received bid setting information, the received bid user ID, and the received bid time in the storage section 130 in association with each other.

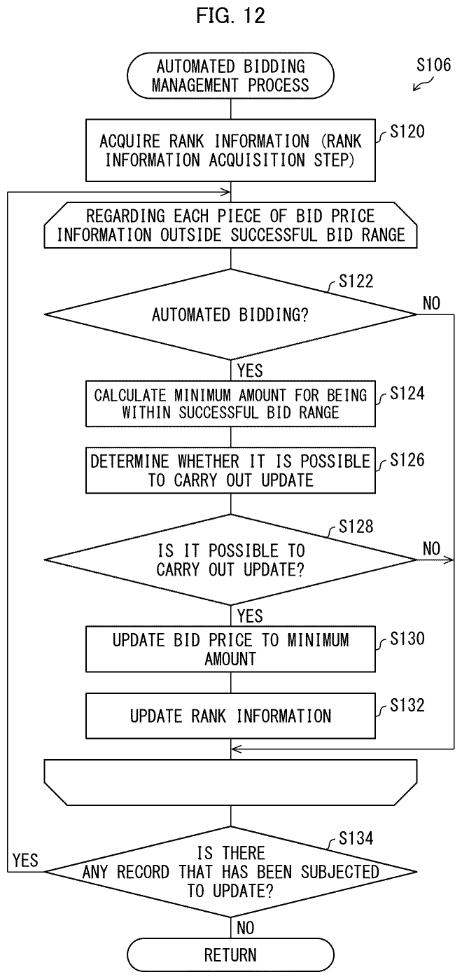

In step S106 (a rank information acquisition step and an automated bidding management step), the control section 110 carries out an automated bidding management process for managing automated bidding on the basis of the rank information. The automated bidding management process will be described in detail with reference to FIG. 12. FIG. 12 is a flowchart illustrating an example of a detailed flow of the automated bidding management process.

As illustrated in FIG. 12, the automated bidding management process includes steps S120 to S134. In step S120, the rank information acquisition section 113 acquires the rank information on the basis of the bid price information and the bid setting information that have been received up to the present time. Assume, for example, that the table T1 illustrated in FIG. 3 is stored in the storage section 130, and new bid price information and new bid setting information are received in step S700. In this case, the rank information acquisition section 113 acquires the rank information by updating the table T1 on the basis of the new bid price information and the new bid setting information.

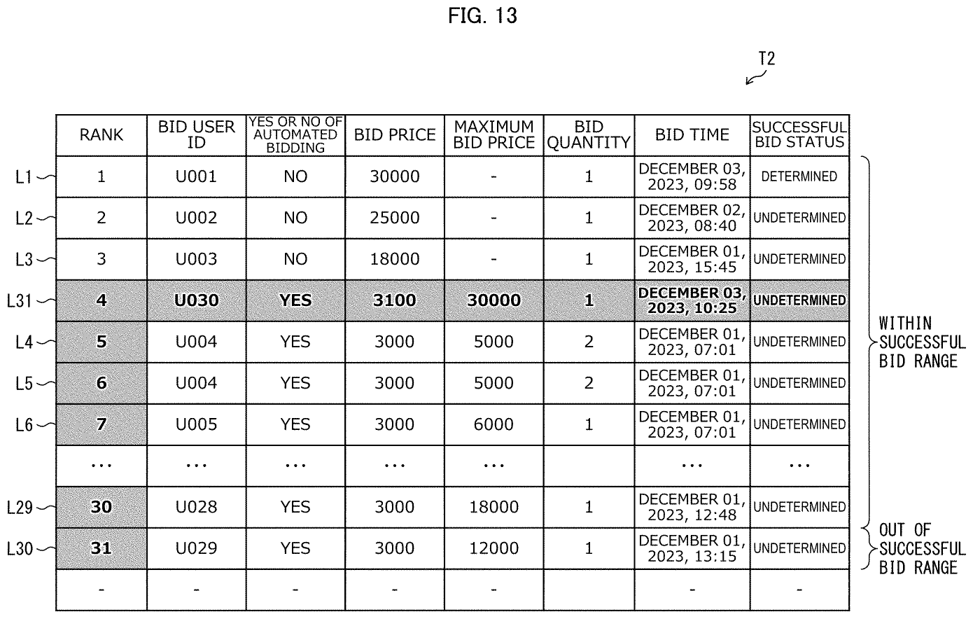

FIG. 13 is a diagram illustrating an example of the rank information updated by a new bid. In FIG. 13, a table T2 is an update of the table T1, and a shaded cell indicates a difference from the table T1. In the table T2, the record L31 indicates the new bid. In this example, the new bid has been made by a new user U030 assuming that automated bidding is selected, the bid price is 3,100 yen, the maximum bid price is 30,000 yen, and the bid quantity is 1. The record L31 is assigned rank 4 as the rank. This is based on a result of rearrangement of the records L1 to L31 including the new record L31 on the basis of at least the bid price. Thus, the ranks of the records L4 to L30 are each moved down by one and updated. The ranks of the records L1 to L29 and L31 are within the successful bid range. The rank of the record L30 is changed from “within-successful bid range” to “out-of-successful bid range” by the table T1 being updated to the table T2.

Subsequently, the automated bidding management section 114 refers to the rank information, and carries out a process in steps S122 to S132 of FIG. 12 in descending order of the rank for each piece of the bid price information outside the successful bid range. In a description of steps S122 to S132, the bid price information that is to be processed is referred to as bid price information to be processed.

In step S122, the automated bidding management section 114 determines whether automated bidding is set in the bid setting information associated with the bid price information to be processed. In a case where a determination result in step S122 is No, the process related to the bid price information to be processed ends, and the bid price information that is at the next rank outside the successful bid range is used as the bid price information to be newly processed to carry out steps S122 to S132. In a case where no bid price information to be newly subjected to the process in steps S122 to S132 is left outside the successful bid range, step S134 described later is carried out. In a case where the determination result in step S122 is Yes, the next step S124 is carried out.

In step S124, the automated bidding management section 114 refers to the rank information and calculates a minimum amount for a rank of the bid price information to be processed to be within the successful bid range. For example, with reference to the table T2 illustrated in FIG. 13, a minimum value of the bid price in the successful bid range is 3,000 yen. In this example, in the case of the same bid price, the bid time that is earlier is assigned a higher rank. Thus, even in a case where the bid price is updated to the bid price having the same amount as the minimum value, the bid price information to be processed cannot be within the successful bid range. In view of the above, the automated bidding management section 114 sets, as the minimum amount for being within the successful bid range, an amount greater than the minimum value. For example, the minimum amount for being within the successful bid range may be a value (for example, 3,100 yen) obtained by adding a prescribed value (for example, 100 yen) to the minimum value.

In step S126, the automated bidding management section 114 determines, on the basis of the bid setting information, whether it is possible to update the bid price indicated by the bid price information to be processed to the minimum amount for being within the successful bid range. For example, in a case where the maximum bid price of automated bidding is set to not less than “the minimum amount for being within the successful bid range” in the bid setting information associated with the bid price information to be processed, the automated bidding management section 114 may determine that such an update is to be carried out. Further, in a case where the maximum bid price is less than “the minimum amount for being within the successful bid range, the automated bidding management section 114 may determine that the update is not to be carried out. Assume, for example, that the table T2 includes 50 records, and up to rank 30 is within the successful bid range. Furthermore, assume that “the minimum amount for being within the successful bid range” is 3,100 yen. In this case, in a case where the maximum bid price of automated bidding is not less than 3,100 yen, each of the records at rank 31 to 50 is determined to be subjected to the update.

Further, in a case where the rank of the bid price information to be processed is within a given rank and the maximum bid price of automated bidding is set to “the minimum amount for being within the successful bid range” or more, the automated bidding management section 114 may determine that the update is to be carried out. In this case, in a case where the rank of the bid price information to be processed is lower than the given rank, regardless of content of the bid setting information, the automated bidding g management section 114 may determine that the update is not to be carried out. For example, in a case where the given rank is rank 40 in the foregoing example of the table T2, and the maximum bid price of automated bidding is not less than 3,100 yen, each of the records at rank 31 to 40 is determined to be subjected to the update. Furthermore, in this case, regardless of the content of the bid setting information, the records at rank 41 to 50 are determined not to be subjected to the update.

Further, in a case where the bid price information to be processed changes from “within-successful bid range” to “out-of-successful bid range” due to the most recent update of the rank information and the maximum bid price of automated bidding is set to not less than “the minimum amount for being within the successful bid range”, the automated bidding management section 114 may determine that the update is to be carried out. In this case, in a case where the rank of the bid price information to be processed is out of the successful bid range also before the most recent update of the rank information, regardless of the content of the bid setting information, the automated bidding management section 114 may determine that the update is not to be carried out. For example, in the foregoing example of the table T2, in a case where the maximum bid price of automated bidding is not less than 3,100 yen, each of the records whose ranks have dropped from rank 30 or higher to rank 31 or lower due to the update from the table T1 to T2 is determined to be subjected to the update. Furthermore, in this case, in each of the tables T1 and T2, regardless of the content of the bid setting information, the records at rank 31 or lower are determined not to be subjected to the update.

In a case where it is determined in S126 that the update is not to be carried out (No in step S128), the process related to the bid price information to be processed ends, and the bid price information that is in the next rank outside the successful bid range is used as the bid price information to be newly processed to carry out steps S122 to S132. In a case where no bid price information to be newly subjected to the process in steps S122 to S132 is left outside the successful bid range, step S134 described later is carried out. In a case where it is determined in S126 that the update is to be carried out (Yes in step S128), the next step S130 is carried out.

In step S130, the automated bidding management section 114 updates the bid price indicated by the bid price information to be processed to the “the minimum amount for being within the successful bid range” calculated in step S124. In step S132, the rank information acquisition section 113 updates the rank information on the basis of the updated bid price. The process related to the bid price information to be processed ends, and the bid price information that is in the next rank outside the successful bid range is used as the bid price information to be newly processed to carry out steps S122 to S132. In a case where no bid price information to be newly subjected to the process in steps S122 to S132 is left outside the successful bid range, step S134 described later is carried out.

An example of the process in steps S122 to S132 will be described with reference to FIGS. 13 to 15. In the table T2 illustrated in FIG. 13, the record L30 at rank 31, which is outside the successful bid range, includes “yes” as yes or no of automated bidding (S122). As described earlier, the minimum amount for being within the successful bid range is calculated to be 3,100 yen (S124). Further, the maximum bid price of 12,000 yen included in the record L30 is not less than “the minimum amount for being within the successful bid range” of 3,100 yen. Thus, the automated bidding management section 114 determines that the record L30 is to be subjected to the update (S126 to S128), and updates the bid price of 3,000 yen to “the minimum amount for being within the successful bid range” of 3,100 yen (S130). Furthermore, the automated bidding management section 114 updates the bid time of the record L30 to a time at which the update was carried out. Moreover, the automated bidding management section 114 rearranges the records L1 to L31 on the basis of the updated bid price and the updated bid time (S132).

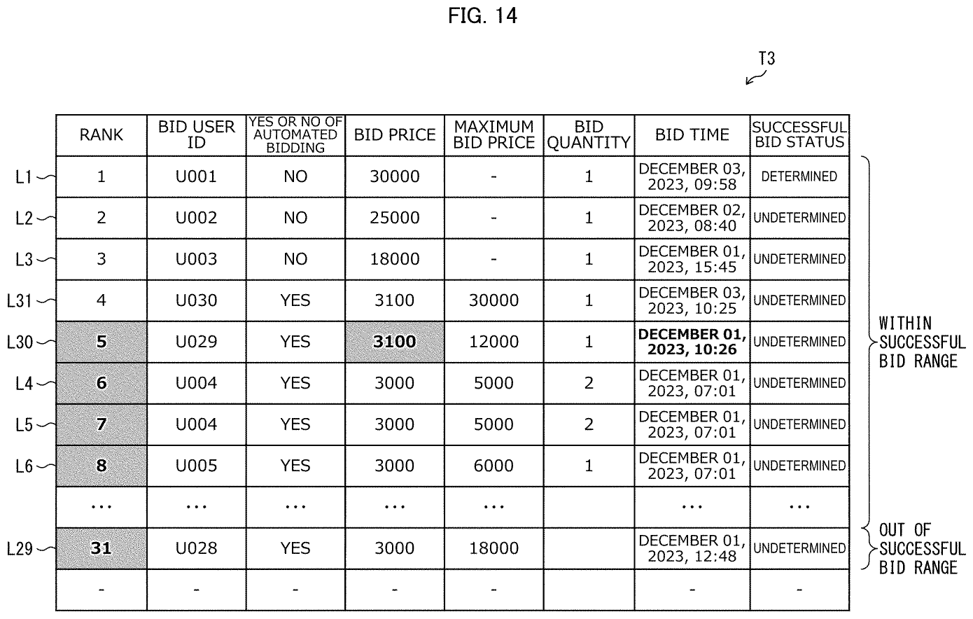

Thus, the table T2 illustrated in FIG. 13 is updated to a table T3 illustrated in FIG. 14. FIG. 14 is a diagram illustrating an example of the rank information updated in step S132. In FIG. 14, the table T3 is an update of the table T2 illustrated in FIG. 13, and a shaded cell indicates a difference from the table T2. In the table T3 illustrated in FIG. 14, the record L30, which is outside the successful bid range in the table T2 illustrated in FIG. 13, is assigned rank 5, which is within the successful bid range.

Further, the record L29 that is newly ranked 31, which is outside the successful bid range, in table T3, includes “yes” as yes or no of automated bidding (S122). Furthermore, in the table T3, the minimum value of the bid price in the successful bid range is 3,000 yen, and 3,100 yen continues to calculated as “the minimum amount for being within the successful bid range” (S124). Moreover, the maximum bid price of 18,000 yen included in the record L29 is not less than “the minimum amount for being within the successful bid range” of 3,100 yen. Thus, the automated bidding management section 114 determines that the record L29 is to be subjected to the update (S126 to S128), and updates the bid price of 3,000 yen to “the minimum amount for being within the successful bid range” of 3,100 yen (S130). Furthermore, the automated bidding management section 114 updates the bid time of the record L29 to a time at which the update was carried out. Moreover, the automated bidding management section 114 rearranges the records L1 to L31 on the basis of the updated bid price and the updated bid time (S132).

Assume, for example, that “the minimum value of the bid price in the successful bid range” has reached 3,100 yen in a process in which steps S122 to S132 are thus carried out for each of the records outside the successful bid range. In this example, as described earlier, in the case of the same bid price, the bid time that is earlier is assigned a higher rank. Thus, even in a case where the bid price is updated to the bid price having the same amount as the minimum value, a record to be processed cannot be within the successful bid range. Thus, the automated bidding management section 114 calculates, as the minimum amount for being within the successful bid range, a value (for example, 3,200 yen) obtained by adding a prescribed value (for example, 100 yen) to the minimum value of 3,100 yen (S124). Subsequently, 3,200 yen thus calculated is used to update the bid price of the record to be processed and update the rank information (S126 to S132).

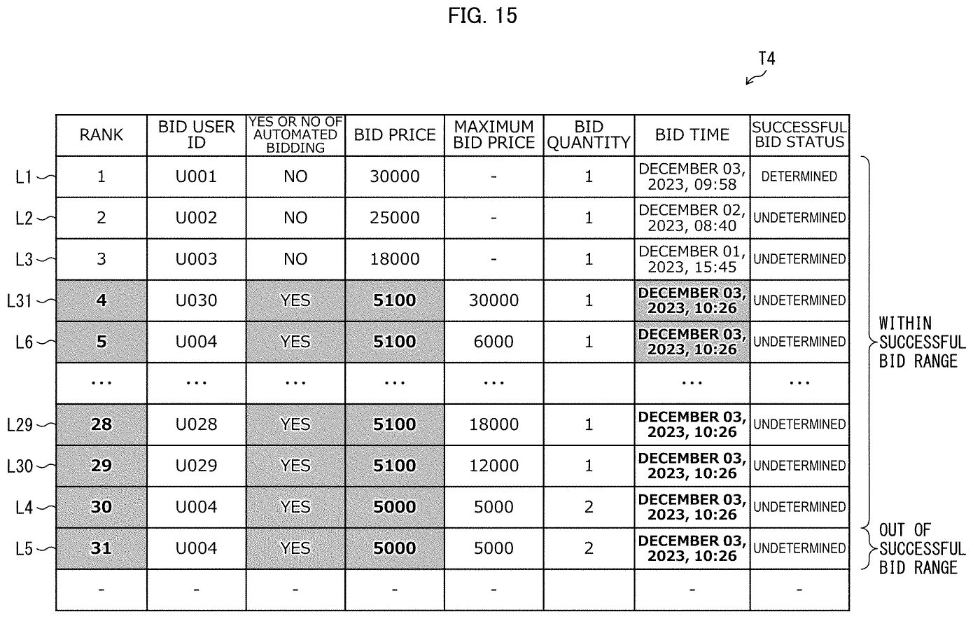

In this way, in a case where steps S122 to S132 are repeated, the table T3 illustrated in FIG. 14 is updated to a table T4 illustrated in FIG. 15. FIG. 15 is a diagram illustrating another example of the rank information updated in step S132. In FIG. 15, the table T4 is an update of the table T3 illustrated in FIG. 14, and a shaded cell indicates a difference from the table T3. In the table T4 illustrated in FIG. 15, the minimum value of the bid price in the successful bid range is 5,000 yen. In this example, as described earlier, in the case of the same bid price, the bid time that is earlier is assigned a higher rank. Thus, even in a case where the bid price is updated to the bid price having the same amount as the minimum value, the record L5 ranked 31, which is outside the successful bid range, cannot be within the successful bid range. For this reason, 5,100 yen is calculated as “the minimum amount for being within the successful bid range” (S122). However, the record L5 includes 5,000 yen as the maximum bid price. The maximum bid price is less than “the minimum amount for being within the successful bid range” of 5,100 yen. Thus, the automated bidding management section 114 determines that the record L5 is not to be subjected to the update (S124).

Upon completion of steps S122 to S132 for each of pieces of the bid price information outside the successful bid range, step S134 is carried out. In step S134, the automated bidding management section 114 determines whether there is at least one piece of the bid price information having been subjected to the update. In a case where a determination result in step S134 is No, the automated bidding management process ends. In a case where the determination result in step S134 is Yes, the automated bidding management section 114 carries out steps S122 to S132 for each of the pieces of the bid price information outside the successful bid range. For example, in the example of the table T4 illustrated in FIG. 15, the record L5 is determined not to be subjected to the update, and in the successful bid range, there is no record that has been subjected to the update. Thus, the automated bidding management process ends.

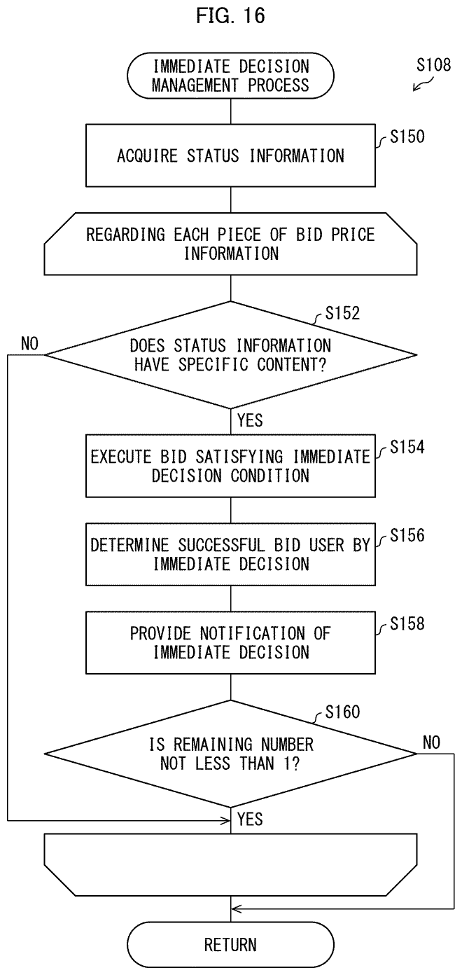

FIG. 7 is referred to again to continuously describe the flow of the information processing method S1 on and after step S108. In step S108 (a status information acquisition step, an immediate decision management step, and an immediate successful bid user determination step), the control section 110 carries out an immediate decision management process for immediately deciding a successful bid user on the basis of the status information. Note that the automated bidding management process in step S106 and the immediate decision management process in step S108 need not necessarily be carried out in this order. For example, step S106 may be carried out after step S108, or steps S106 and S108 may be simultaneously carried out. The immediate decision management process in step S108 will be described in detail with reference to FIG. 16. FIG. 16 is a flowchart illustrating an example of a detailed flow of the immediate decision management process. As illustrated in FIG. 16, the immediate decision management process includes steps S150 to S160.

In step S150, the status information acquisition section 116 acquires status information indicating a status of the auction. For example, the status information acquisition section 116 may acquire, as the status information, information indicating a remaining number obtained by subtracting, from the number of listing media in the auction, the number of listing media for which a successful bid has been made. The information indicating the remaining number may be acquired by referring to a table, the examples of which are illustrated in FIGS. 3 and 13 to 15. For example, in the table T4 illustrated in FIG. 15, the remaining number “29” is calculated by subtracting, from the number “30” of the listing media, the number “1” of records in which the successful bid status is “determined”.

Further, for example, the status information acquisition section 116 may acquire, as the status information, information indicating the bid price of another bid user who bids in the auction. For example, the bid price of the another bid user which bid price is acquired as the status information may be the minimum value of the bid price in the successful bid range. Such a bid price of the another bid user may be acquired by referring to the table, the examples of which are illustrated in FIGS. 3 and 13 to 15. For example, in the table T4 illustrated in FIG. 15, the minimum value of the bid price in the successful bid range is “5,000 yen”.

Furthermore, for example, the status information acquisition section 116 may acquire, as the status information, information indicating the number of bid users s who bid in the auction. The information indicating the number of bid users may be acquired by referring to the table, the examples of which are illustrated in FIGS. 3 and 13 to 15. For example, in the table T4 illustrated in FIG. 15, the number of bid users U001 to U030 identified by the bid user ID is “30”.

Moreover, for example, the status information acquisition section 116 may acquire, as the status information, information indicating remaining time until a deadline set in advance expires. The information indicating the remaining time may be obtained by referring to the bidding deadline included in the listing medium information.

Subsequently, the control section 110 carries out steps S152 to S158 for each of pieces of the bid price information which pieces have been received so far. In step S152, the immediate decision management section 118 determines whether the status information has specific content set in advance. The specific content set in advance is included in the immediate decision instruction information included in the bid setting information associated with the bid price information.

For example, the immediate decision management section 118 may determine whether the foregoing remaining number indicated by the status information is not more than a prescribed number. Further, for example, the immediate decision management section 118 may determine whether the foregoing bid price of the another bid user which bid price is indicated by the status information is not less than a prescribed amount. Moreover, for example, the immediate decision management section 118 may determine whether the foregoing number of bid users which number is indicated by the status information is not less than a prescribed number. In addition, for example, the immediate decision management section 118 may determine whether the foregoing remaining time indicated by the status information is not more than a prescribed time.

In a case where it is determined in step S152 that the status information does not have the specific content, the process related to the bid price information ends, and the process in steps S152 to S158 is carried out for the next piece of the bid price information. In a case where it is determined in step S152 that the status information has the specific content, step S154 is carried out.

In step immediate decision S154, the management section 118 updates the bid price indicated by the bid price information to the buyout price in order to execute the bid which satisfies the immediate decision condition. Assume, for example, that the buyout price is set to 30,000 yen in the listing setting information associated with the table T4, the example of which is illustrated in FIG. 15. Further, assume that the bid setting information associated with the record L31 includes the immediate decision instruction information indicating that “the bid which satisfies the immediate decision condition is executed in a case where the minimum value of the bid price in the successful bid range is not less than 25,000 yen and the remaining time is not more than 2 hours”. In this case, in a case where the minimum value of the bid price in the successful bid range is not less than 25,000 yen and the remaining time is not more than 2 hours (Yes in S152), the bid price of the record L31 is updated to 30,000 yen, which is the buyout price.

In step S156, on the basis of the foregoing bid which satisfies the immediate decision condition, the successful bid user determination section 119 determines, as a successful bid user who successfully bids for a listing medium, a bid user who is associated with the immediate decision instruction information. For example, in the table T4 illustrated in FIG. 15, in a case where the bid price included in the record L31 is updated to 30,000 yen, which is the buyout price, the successful bid user determination section 119 determines, as the successful bid user, the bid user U030 indicated by the record L31. Further, the successful bid user determination section 119 updates the successful bid status of the record L31 in the table T4 from “undetermined” to “determined”.

In step S158, the notification section 120 transmits, to the bid user terminal 70 used by the successful bid user who has been immediately decided, information notifying that an immediate decision has been made. The information notifying that the immediate decision has been made may include the status information which has triggered the immediate decision. For example, the information notifying that the immediate decision has been made may include text such as “an immediate decision was made at the buyout price of 30,000 yen because the minimum value of the bid price in the successful bid range has reached 25,000 yen or more, and the remaining time has reached 2 hours or less”.

In step S160, the control section 110 determines whether the remaining number of listing media is one or more as a result of immediately deciding the successful bid user. In a case where it is determined that the remaining number is one or more, the process in steps S152 to S158 is repeated for the next piece of the bid price information. In a case where it is determined that the remaining number is 0, or in a case where the process in steps S152 to S158 ends for all pieces of the bid price information, the immediate decision management process ends.

FIG. 7 is referred to again to continuously describe the flow of the information processing method S1 on and after step S110. In step S110, the notification section 120 refers to the latest rank information and notifies a bid user who is associated with the bid price information whose rank is lower than the successful bid range of “out-of-successful bid range”. For example, the notification section 120 refers to the table T4 illustrated in FIG. 15 and transmits, to the bid user terminal 70 that is used by the bid user U028 indicated by the record L29 ranked 31, which is outside the successful bid range, the information providing notification of “out-of-successful bid range”.

In step S702, upon reception of the information providing notification of “out-of-successful bid range”, the out-of-successful bid range reception section 712 of the bid user terminal 70 outputs “out-of-successful bid range” in a manner recognizable to the bid user. For example, in a case where manual bidding is set, the bid user who has received the notification can take action such as carrying out re-bidding in order to come within the successful bid range. Further, in a case where automated bidding is set, the bid user who has received the notification can take action such as paying attention to the progress caused by automated bidding, changing setting of automated bidding, etc.

In step S112, the control section 110 of the auction server 10 determines whether a termination condition under which a bidding period for the auction ends is satisfied. In a case where the termination condition is not satisfied, the process in steps S700 and S104 to S110 is repeated. In a case where the termination condition is satisfied, subsequent step S114 is carried out.

In step S114, the successful bid user determination section 119 determines, among a plurality of bid users, a plurality of successful bid users who successfully bid for at least some of a plurality of listing media that have an identical type. For example, after the end of the bidding period, the successful bid user determination section 119 may determine, as a successful bid user, a bid user indicated by the bid user ID associated with the bid price information within the successful bid range in the rank information. Assume, for example, that the table T4 illustrated in FIG. 15 is stored in the storage section 130 after the end of the bidding period. In this case, the successful bid user determination section 119 determines, as successful bid users, bid users indicated by bid user IDs included in the records L1 to L3, L31, L6 to L29, and L4 within the successful bid range. Further, the successful bid user determination section 119 updates, to “determined”, a record, the successful bid status of which is “undetermined”, among these records in the table T4.

In a case where the bid quantity included in the bid setting information is two or more, with reference to yes or no of “purchase of a part of the desired quantity” included in the bid setting information, the successful bid user determination section 119 may determine whether to allow a successful bid to be made. For example, in the foregoing example of the table T4, the records L4 and L5 each indicate the bid, which is made by the bid user U004 and the bid quantity of which is 2. Among these, the record L4 is ranked 30, which is within the successful bid range, whereas the record L5 is ranked 31, which is outside the successful bid range. In this case, in a case where setting of “purchase of a part of the desired quantity” corresponding to the records L4 and L5 is “yes”, a successful bid is determined for the record L4, and an unsuccessful bid is determined for the record L5. In other words, the bid user U004 can successfully bid for one, which is a part of the bid quantity of 2.

In contrast, in a case where the setting of “purchase of a part of the desired quantity” corresponding to the records L4 and L5 is “no”, an unsuccessful bid is determined for both the records L4 and L5. In other words, in a case where at least one of the records corresponding to two, which is the bid quantity, is outside the successful bid range, the bid user U004 cannot successfully bid for the two. In this case, in a case where records ranked 32 or lower are present, a successful bid is determined for a record the desired quantity of which is 1 or a record which is ranked highest among records in which the setting of “purchase of a part of the desired quantity” is “yes”.

In step S116, the notification section 120 notifies the listing user terminal 50 and the bid user terminal 70 of a successful bid result. Further, in a case where an NFT is associated with a listing medium, the notification section 120 notifies the blockchain system 90 that an owner of the listing medium has been changed from a listing user to a bid user.

For example, the successful bid result of which the listing user terminal 50 is notified may include information indicating the bid user who has successfully bid for the listing medium. For example, the successful bid result may be a list of bid users who have successfully bid for a respective plurality of listing media having an identical type. Further, the successful bid result of which the bid user terminal 70 is notified may include information indicating whether a successful bid has been made or a successful bid quantity. For example, in the foregoing example of the table T4, the successful bid result of which the bid user U004 is notified may include information indicating that the successful bid quantity is 1 among the bid quantity of 2.

In step S704, the successful bid result reception section 713 of the bid user terminal 70 outputs the received successful bid result in a manner recognizable to the bid user. An example of a recognizable manner is as described earlier. Further, in step S706, in a case where there is a listing medium for which a successful bid has been made, the successful bid result reception section 713 stores, in the storage section 730, the medium information indicating the listing medium. Note that steps S704 and S706 need not necessarily be carried out in this order. Alternatively, the order in which S704 and S706 are carried out may be reversed, or S704 and S706 may be simultaneously carried out.

In step S504, the listing medium notification section 512 of the listing user terminal 50 outputs the received successful bid result in a manner recognizable to the listing user, and transmits the successful bid result to the game server 30. Further, in step S506, the listing medium notification section 512 deletes, from the storage section 530, the medium information indicating the listing medium for which a successful bid has been made. Note that steps S504 and S506 need not necessarily be carried out in this order. Alternatively, the order in which S504 and S506 are carried out may be reversed, or S504 and S506 may be simultaneously carried out.

In step S302, upon reception of the successful bid result from the listing user terminal 50, the medium management section 311 of the game server 30 updates the listing status information, which is associated with medium information of a game medium indicated by the successful bid result, so as to indicate that the game medium is not being listed. With this, the medium management section 311 makes it possible to use the game medium in the game. Further, in step S304, the medium management section 311 changes the owner information of the game medium, which owner information is indicated by the medium information, from the listing user to the bid user. Note that steps S302 and S304 need not necessarily be carried out in this order. Alternatively, the order in which S302 and S304 are carried out may be reversed, or S302 and S304 may be simultaneously carried out. This concludes the information processing method S1 carried out by the system 1.

### Variation 1

In the foregoing embodiment, an example has been described in which the minimum bid price included in the listing setting information is applied as the initial value of the bid price in automated bidding. The initial value of the bid price in automated bidding is not limited to this and may be designatable by the bid user. In this case, for example, the example screen G3 illustrated in FIG. 10 may include a UI object that receives input of the initial value of the bid price. This makes it possible to avoid starting from a bid price that is too low as compared with a market price, and to form a market price in the auction at an early stage.

### Variation 2

Further, in the foregoing embodiment, whether to carry out automated bidding may be switchable after the bid on the basis of an operation by the bid user. Assume, for example, that the bid setting information associated with the bid price information indicating the bid price set by manual bidding has been changed so that automated bidding is carried out. For example, the example screens G3 and G4 of FIGS. 10 and 11 may be used to carry out such a change in bid setting information. In this case, on the basis of the bid price manually input most recently, the automated bidding management section 114 updates the bid price information by automated bidding without thereafter updating the bid price information on the basis of input by the bid user.

Further, assume, for example, that the bid setting information associated with the bid price information indicating the bid price set by automated bidding has been changed so that automated bidding is not carried out. In this case, the automated bidding management section 114 updates the bid price information on the basis of input by the bid user, without hereinafter updating the bid price information by automated bidding. Furthermore, in this case, at the start of manual bidding after the change, the bid price and the bid quantity that have been updated most recently in automated bidding may be maintained.

### Variation 3

Further, in the foregoing embodiment, a description has been provided assuming that, an ascending order of the bid time and a descending order of the bid quantity are applied in this order in order to assign ranks to a plurality of pieces of the bid price information which pieces are identical in bid price. Note, however, that types of information referred to in order to assign ranks to the plurality of pieces of the bid price information which pieces are identical in bid price and an order in which pieces of the information are applied are not limited to the above. For example, first, a higher rank may be assigned, in descending order of the bid quantity, to the plurality of pieces of the bid price information which pieces are identical in bid price, and, next, a higher rank may be assigned, in ascending order of the bid time, to a plurality of pieces of the bid price information which pieces are identical in bid price and bid quantity. With this, a bid user who wishes to purchase more of a plurality of listing media having the same type is preferentially treated.

Further, in a case where the bid quantity is two or more, a high rank may be assigned preferentially to the bid price information corresponding to a part of the bid quantity, and a lower rank may be assigned to the bid price information corresponding to another part of the bid quantity. For example, a rank may be assigned first to the bid price information corresponding to at least a part (e.g., a first bid) of the bid quantity for each of a plurality of bid users. Furthermore, in this case, in a case where there is another part (e.g., second and later bids) of the bid quantity for each of the bid users, for the bid price information corresponding to the another part, a rank lower than the lowest rank among the ranks assigned to the respective pieces of the bid price information corresponding to the first bid may be assigned to the bid price information corresponding to the another part. This allows more bid users to successfully bid for a plurality of listing media having an identical type.

### Variation 4

Further, in the foregoing embodiment, step S124 in the automated bidding management process illustrated in FIG. 12 can be modified as follows. For example, in the case of the same bid price, in a case where a high rank is assigned with reference to other information different from the bid time, the minimum value in the successful bid range may be “the minimum amount for being within the successful bid range”. Assume, for example, that a higher rank is assigned to a higher bid quantity in the case of the same bid price. In this case, in a case where the bid quantity associated with the bid price information to be processed outside the successful bid range is higher than the bid quantity associated with the bid price information having the minimum value in the successful bid range, the bid price information to be processed is within the successful bid range by the bid price being updated to the minimum value. Thus, in step S124 of FIG. 12, for the bid price information to be processed, the automated bidding management section 114 may calculate a provisional rank in a case where the bid price is updated to the minimum value in the successful bid range. Furthermore, in a case where the calculated provisional rank is within the successful bid range, the automated bidding management section 114 may calculate the minimum value as “the minimum amount for being within the successful bid range”. Moreover, in a case where the provisional rank is still outside the successful bid range, the automated bidding management section 114 may calculate, as “the minimum amount for being within the successful bid range”, an amount obtained by adding a prescribed amount to the minimum value.

Further, in the foregoing embodiment, the automated bidding management process illustrated in FIG. 12 can be modified as follows. For example, the automated bidding management section 114 updates the rank information so that new bid price information acquired in step S104 is within the successful bid range. Next, the automated bidding management section 114 specifies, as a new “out-of-successful bid range”, the bid price information whose maximum bid price associated with each piece of the bid price information is the lowest among a plurality of pieces of the bid price information for which automated bidding is set at or below a rank of the new bid price information. In a case where there are a plurality of pieces of the bid price information whose maximum bid price is the lowest, the automated bidding management section 114 specifies, as a new “out-of-successful bid range”, the bid price information that is later in bid time. Subsequently, the automated bidding management section 114 determines, as a new re-bid price, an amount obtained by adding a prescribed amount to the lowest maximum bid price. Then, the automated bidding management section 114 updates, to the determined re-bid price, the bid price of each of the pieces of the bid price information for which automated bidding is set at or below a rank of the new bid price information in the successful bid range. Next, the automated bidding management section 114 updates the rank information on the basis of the updated bid price. With this, without carrying out an iterative process as illustrated in FIG. 12, it is possible to update, for example, the table T2 to the table T4 that cannot be further updated.

### Variation 5

In the foregoing embodiment, a description has been provided assuming that a bid user can select, in one auction, whether to carry out automated bidding or manual bidding. Alternatively, the foregoing embodiment may be configured such that a listing user can set a bidding method for each auction. As the bidding method that can be set, automated bidding only can be set, manual bidding only can be set, or both automated bidding and manual bidding can be set. Since a process or result of an auction can vary depending on the bidding method, setting the bidding method for each auction makes it possible to achieve an auction that is more suitable for listing content. An auction in which the bidding method is set to “automated bidding only” by the listing user may be configured such that only a bid user who has carried out setting of “carrying out automated bidding in any auction” in advance can participate in a bid, or such that automated bidding automatically carried out simultaneously with bidding is set.

### Variation 6

In the foregoing embodiment, the number of bids that can be made by one bid user for one auction is one. Note that one bid herein means a bid to which the same bid setting information is applied. The above embodiment may be modified so that one bid user can make a plurality of bids for one auction. This makes it possible to differentiate pieces of the bid setting information in the respective plurality of bids. For example, the bid user can make a plurality of bids for one auction, set a high maximum bid price in one bid, and set a low maximum bid price in the other bid(s). With this, for example, the bid user can employ a strategy of increasing reliability of acquisition for at least one by the bid in which the high maximum bid price is set, and acquiring the others in a case where the others are inexpensive. Note that the present variation may be configured such that a listing user can set an upper limit of the number of bids which can be made by one bid user.

### Variation 7

In the foregoing embodiment, an example has been mainly described in which the listing medium information indicates a plurality of listing media having an identical type. Note, however, that the listing medium information may be information indicating only one listing medium, or may be information indicating a plurality of: listing media including at least two different types of listing media. Also in this case, in particular, the immediate decision management process in step S108 can be similarly carried out. Further, in the foregoing embodiment, the bid price information acquisition section 112 has been described as receiving bids from a respective plurality of bid users. Note, however, that the bid price information acquisition section 112 may receive a bid from at least one bid user. Also in this case, in particular, the immediate decision management process in step S108 can be similarly carried out.

### Variation 8

Further, a device configuration constituting the system 1 is not limited to the configuration illustrated in FIG. 1. For example, the auction server 10 and the game server 30 may be provided on the same computer. Furthermore, the auction server 10 and/or the game server 30 may be one of the distributed nodes in the blockchain system 90. Moreover, the listing user terminal 50 and the bid user terminal 70 may be constituted by the same terminal.

### Supplementary Note

From the above description, the present invention is understood, for example, as below. In order to facilitate understanding of the present invention, in the following description, reference signs in parentheses which reference signs correspond to the attached drawings will be used for convenience to discuss the present invention. However, this is not intended to limit the present invention to the aspects illustrated in the drawings.

A system (1) in accordance with Aspect 1 includes: a listing medium information acquisition section (111) that acquires, from a listing user who lists a plurality of listing media which have an identical type and which are listed in one auction, listing medium information indicating the plurality of listing media; a bid price information acquisition section (112) that acquires bid price information indicating a bid price of each of a plurality of bid users who bid in the auction; a successful bid user determination section (119) that determines, among the plurality of bid users, a plurality of successful bid users who successfully bid for at least some of the plurality of media; listing a rank information acquisition section (113) that acquires rank information indicating a rank of the bid price information in descending order of the bid price; and an automated bidding management section (114) that, until a termination condition under which a bidding period for the auction ends is satisfied, (i) determines, on the basis of advance setting by a bid user who is associated with the bid price information, whether it is possible to update the bid price indicated by the bid price information whose rank is outside a successful bid range set on the basis of the number of the listing media to a minimum bid price for the rank to be within the successful bid range, and (ii) updates the bid price in a case where the bid price is determined to be updatable. The above configuration allows more users to make a purchase at a minimum amount or at an amount close to the minimum amount. This improves a sense of fairness.

In Aspect 2, a system (1) is configured such that, in Aspect 1, the advance setting by the bid user includes an upper limit of the bid price to be updated. The above configuration makes it possible to prevent the bid user from making a bid at a higher amount than expected.

In Aspect 3, a system (1) is configured such that, in Aspect 1 or 2, a time at which a bid was made at the bid price indicated by the bid price information is associated with the bid price information, and the rank information indicates that, in a case where there are a plurality of pieces of the bid price information which pieces are identical in bid price, a piece of the bid price information which piece is earlier in bid time at which a bid was made at the bid price is in a higher rank. According to the above configuration, in an auction in which a plurality of successful bid users appear, there is a case where a user who was able to make a successful bid and a user who was unable to make a successful bid appear despite the fact that those users are identical in bid price. In such a case, a degree of understanding of the user who was unable to make a successful bid is improved.

In Aspect 4, a system (1) is configured such that, in any one of Aspects 1 to 3, information indicating a bid unit, which is a minimum quantity of listing media to be bid, is associated with the listing medium information. The above configuration makes it possible to prevent a successful bid for listing media that are desirably used in the minimum quantity from being made with a quantity less than the minimum quantity.

In Aspect 5, a system (1) is configured such that, in any one of Aspects 1 to 3, information indicating an upper limit number of listing media for which one successful bid user is able to successfully bid is associated with the listing medium information. The above configuration allows more bid users to successfully bid for a plurality of listing media having an identical type.

In Aspect 6, a system (1) is configured to, in any one of Aspects 1 to 5, further include a notification section (120) that provides a bid user who is associated with the bid price information whose rank is lower than the successful bid range with notification that the bid user is outside the successful bid range. The above configuration allows the bid user who has fallen outside the successful bid range to know this fact.

In Aspect 7, a system (1) is configured such that, in any one of Aspects 1 to 6, the at least one listing medium is an electronic medium with which a non-fungible token whose owner is managed on a blockchain is associated. The above configuration makes it possible to maintain credibility of the electronic medium. For example, it is possible to show that the electronic medium has not been generated by an inappropriate activity. Further, the non-fungible token being associated with the electronic medium makes it possible to easily acquire information pertaining to a transaction history.

A method (S1) in accordance with Aspect 8 is a method carried out by at least one computer, the method including: a listing medium information acquisition step (S100) of acquiring, from a listing user who lists a plurality of listing media which have an identical type and which are listed in one auction, listing medium information indicating the plurality of listing media; a bid price information acquisition step (S104) of acquiring bid price information indicating a bid price of each of a plurality of bid users who bid in the auction; a successful bid user determination step (S114) of determining, among the plurality of bid users, a plurality of successful bid users who successfully bid for at least some of the plurality of listing media; a rank information acquisition step (S106) of acquiring rank information indicating a rank of the bid price information in descending order of the bid price; and an automated bidding management step (S106) of, until a termination condition under which a bidding period for the auction ends is satisfied, (i) determining, on the basis of advance setting by a bid user who is associated with the bid price information, whether it is possible to update the bid price indicated by the bid price information whose rank is outside a successful bid range set on the basis of the number of the listing media to a minimum bid price for the rank to be within the successful bid range, and (ii) updates the bid price in a case where the bid price is determined to be updatable. The above configuration brings about an effect similar to that brought about by Aspect 1.

A program in accordance with Aspect 9 causes at least one computer to carry out: a listing medium information acquisition step (S100) of acquiring, from a listing user who lists a plurality of listing media which have an identical type and which are listed in one auction, listing medium information indicating the plurality of listing media; a bid price information acquisition step (S104) of acquiring bid price information indicating a bid price of each of a plurality of bid users who bid in the auction; a successful bid user determination step (S114) of determining, among the plurality of bid users, a plurality of successful bid users who successfully bid for at least some of the plurality of listing media; an acquisition step (S106) of acquiring rank information indicating a rank of the bid price information in descending order of the bid price; and an automated bidding management step (S106) of, until a termination condition under which a bidding period for the auction ends is satisfied, (i) determines, on the basis of advance setting by a bid user who is associated with the bid price information, whether it is possible to update the bid price indicated by the bid price information whose rank is outside a successful bid range set on the basis of the number of the listing media to a minimum bid price for the rank to be within the successful bid range, and (ii) updates the bid price in a case where the bid price is determined to be updatable. The above configuration brings about an effect similar to that brought about by Aspect 1.

A system (1) in accordance with Aspect 10 includes: a listing medium information acquisition section that acquires, from a listing user who lists at least one listing medium which is listed in an auction, listing medium information indicating the at least one listing medium; a bid price information acquisition section (111) that acquires bid price information indicating a bid price of at least one bid user who bids in the auction; immediate decision condition an acquisition section (115) that acquires immediate decision condition information indicating an immediate decision condition for determining a successful bid user who successfully bids for the at least one listing medium before a deadline set in advance as a bidding deadline for the auction expires; a status information acquisition section (116) that acquires status information indicating status of the auction; an immediate decision instruction information acquisition section (117) that acquires immediate decision instruction information indicating an immediate decision instruction to, in a case where the status information has specific content set in advance, execute a bid which satisfies the immediate decision condition; an immediate decision management section (118) that, in a case where the status information has the specific content set in advance, executes, on the basis of the immediate decision instruction information, the bid which satisfies the immediate decision condition; and a successful bid user determination section (119) that, on the basis of the bid which has been executed by the immediate decision management section and which satisfies the immediate decision condition, determines, as a successful bid user who successfully bids for the at least one listing medium, the at least one bid user who is associated with the immediate decision instruction information. The above configuration makes it possible to provide a bid user with a system that enables an immediate decision in accordance with a status of an auction. For example, it is possible to reduce an immediate decision that is made by a bidder at an unnecessarily high price, and to allow a bid user to make an immediate decision with a margin with respect to an auction end time without managing the auction end time.

In Aspect 11, a system (1) is configured such that, in Aspect 10, the listing medium information acquisition section (111) acquires, from the listing user, the listing medium information indicating a plurality of listing media which the at least one listing medium comprises, which have an identical type, and which are listed in one auction, the bid price information acquisition section (112) acquires the bid price information indicating the bid price of each of a plurality of bid users which the at least one bid user comprises, the successful bid user determination section determines, among the plurality of bid users, a plurality of successful bid users who successfully bid for at least some of the plurality of listing media, the status information includes information indicating a remaining number obtained by subtracting, from the number of the plurality of listing media, the number of listing media for which a successful bid has been made, and the immediate decision instruction information is information indicating an instruction to, in a case where the remaining number is not more than a prescribed number, execute the bid which satisfies the immediate decision condition. According to the above configuration, for one auction in which a plurality of listing media having an identical type are listed, it is possible to make a successful bid by an immediate decision before a successful bid is made for all the listing media. Further, it is possible to reduce an immediate decision that is made by a bid user at an unnecessarily high price.

In Aspect 12, a system (1) is configured such that, in Aspect 10 or 11, the status information includes information indicating a bid price of another bid user, and the immediate decision instruction information is information indicating an instruction to, in a case where the bid price is not less than a prescribed amount, execute the bid which satisfies the immediate decision condition. According to the above configuration, an increase in bid price of another bid user makes it highly likely for the bid price to reach a buyout price. According to the present configuration, an immediate decision can be made before a bid price by another bid user reaches a buyout price.

In Aspect 13, a system (1) is configured such that, in any one of Aspects 10 to 12, the status information includes information indicating the number of the at least one bid user who bids in the auction, and the immediate decision instruction information is information indicating an instruction to, in a case where the number of the at least one bid user is not less than a prescribed number, execute the bid which satisfies the immediate decision condition. According to the above configuration, an increase in number of bid users makes it highly likely to prevent a successful bid from being made. According to the present configuration, an immediate decision can be made also in such a case.

In Aspect 14, a system (1) is configured such that, in any one of Aspects 10 to 13, the status information includes information indicating remaining time until the deadline set in advance expires, and the immediate decision instruction information is information indicating an instruction to, in a case where the remaining time is not more than a prescribed time, execute the bid which satisfies the immediate decision condition. According to the above configuration, an immediate decision can be made with a margin in the remaining time. For example, in a case where the remaining time is short, a risk occurs that an instruction for an immediate decision is not reflected due to, for example, server congestion. However, the present configuration makes it possible to reduce such a risk.

In Aspect 15, a system (1) is configured such that, in any one of Aspects 10 to 14, the listing medium information acquisition section (111) acquires, from the listing user, the listing medium information indicating a plurality of listing media which the at least one listing medium comprises, which have an identical type, and which are listed in one auction, the bid price information acquisition section (112) acquires the bid price information indicating the bid price of each of a plurality of bid users which the at least one bid user comprises, and the successful bid user determination section (119) determines, among the plurality of bid users, a plurality of successful bid users who successfully bid for at least some of the plurality of listing media. The above configuration makes it possible to carry out an auction of a medium, the acquisition of two or more of which is valuable, such as an electronic medium used in multiple units.

In Aspect 16, a system (1) is configured, in any one of Aspects 10 to 15, to further include: a rank information acquisition section (113) that acquires rank information indicating a rank of the bid price information in descending order of the bid price; and an automated bidding management section (114) that, until a termination condition under which a bidding period for the auction ends is satisfied, (i) determines, on the basis of advance setting by the at least one bid user who is associated with the bid price information, whether it is possible to update the bid price indicated by the bid price information whose rank is outside a successful bid range set on the basis of the number of the at least one listing medium to a bid price for the rank to be within the successful bid range, and (ii) updates the bid price in a case where the bid price is determined to be updatable. The above configuration makes it possible to increase the possibility of making a successful bid, while reducing effort of a user to monitor a status of an auction.

In Aspect 17, a system (1) is configured such that, in any one of Aspects 10 to 16, the at least one listing medium is an electronic medium with which a non-fungible token whose owner is managed on a blockchain is associated. The above configuration makes it possible to maintain credibility of the electronic medium. For example, it is possible to show that the electronic medium has not been generated by an inappropriate activity. Further, the non-fungible token being associated with the electronic medium makes it possible to easily acquire information pertaining to a transaction history.

A method (S1) in accordance with Aspect 18 is carried out by at least one computer, the method including: a listing medium information acquisition step (S100) of acquiring, from a listing user who lists at least one listing medium which is listed in an auction, listing medium information indicating the at least one listing medium; a bid price information acquisition step (S104) of acquiring bid price information indicating a bid price of at least one bid user who bids in the auction; an immediate decision condition acquisition step (S100) of acquiring immediate decision condition information indicating an immediate decision condition for determining a successful bid user who successfully bids for the at least one listing medium before a deadline set in advance as a bidding deadline for the auction expires; a status information acquisition step (S108) of acquiring status information indicating a status of the auction; an immediate decision instruction information acquisition step (S104) of acquiring immediate decision instruction information indicating an immediate decision instruction to, in a case where the status information has specific content set in advance, execute a bid which satisfies the immediate decision condition; an immediate decision management step (S108) of, in a case where the status information has the specific content set in advance, executing, on the basis of the immediate decision instruction information, the bid which satisfies the immediate decision condition; and a successful bid user determination step (S108) of, on the basis of the bid which has been executed by the immediate decision management step (S108) and which satisfies the immediate decision condition, determining, as a successful bid user who successfully bids for the at least one listing medium, the at least one bid user who is associated with the immediate decision instruction information. The above configuration brings about an effect similar to that brought about by Aspect 10.

A program in accordance with Aspect 19 causes at least one computer to carry out: a listing medium information acquisition step (S100) of acquiring, from a listing user who lists at least one listing medium which is listed in an auction, listing medium information indicating the at least one listing medium; a bid price information acquisition step (S104) of acquiring bid price information indicating a bid price of at least one bid user who bids in the auction; an immediate decision condition acquisition step (S100) of acquiring immediate decision condition information indicating an immediate decision condition for determining a successful bid user who successfully bids for the at least one listing medium before a deadline set in advance as a bidding deadline for the auction expires; a status information acquisition step (S108) of acquiring status information indicating a status of the auction; an immediate decision instruction information acquisition step (S104) of acquiring immediate decision instruction information indicating an immediate decision instruction to, in a case where the status information has specific content set in advance, execute a bid which satisfies the immediate decision condition; an immediate decision management step (S108) of, in a case where the status information has the specific content set in advance, executing, on the basis of the immediate decision instruction information, the bid which satisfies the immediate decision condition; and a successful bid user determination step (S108) of, on the basis of the bid which has been executed by the immediate decision management section (119) and which satisfies the immediate decision condition, determining, as a successful bid user who successfully bids for the at least one listing medium, the at least one bid user who is associated with the immediate decision instruction information. The above configuration brings about an effect similar to that brought about by Aspect 10.

### [Software Implementation Example]

Functions of each device (hereinafter called “device”) constituting the system 1 can be carried out by a program that is for causing a computer to function as the device and that is for causing the computer to function as each of control blocks of the device (in particular, each of sections included in the control section 110 of the auction server 10).

In this case, the device includes a computer that has, as hardware for executing the program, at least one control device (e.g., a processor) and at least one storage device (e.g., a memory). The functions described in the embodiments are carried out by using the control device and the storage device to execute the program.

The program may be recorded in at least one non-transitory computer-readable recording medium. Such a recording medium may be included or need not be included in the device. In the latter case, the program may be supplied to the device via any wired or wireless transmission medium.

Some or all of the functions of the control blocks can be realized by a logic circuit. For example, the present invention encompasses, in its scope, an integrated circuit in which a logic circuit that functions as each of the control blocks is formed. Alternatively, the functions of the control blocks can be realized by, for example, a quantum computer.

Further, each of the processes described in the embodiments may be carried out by artificial intelligence (AI). In this case, AI may be operated by the control device, or may be operated by another device (for example, an edge computer, a cloud server, or the like).

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 System
10 Auction server
30 Game server
50 Listing user terminal
70 User terminal
90 Blockchain system
11, 31, 51, 71 Processor
12, 32, 52, 72 Memory
13, 33, 53, 73 Communication interface
19, 39, 59, 79 Bus
54, 74 Input device
55, 75 Display device
110, 310, 510, 710 Control section
130, 330, 530, 730 Storage section
111 Listing medium information acquisition section
112 Bid price information acquisition section
113 Rank information acquisition section
114 Automated bidding management section
115 Immediate decision condition acquisition section
116 Status information acquisition section
117 Immediate decision instruction information acquisition section
118 Immediate decision management section
119 Successful bid user determination section
120 Notification section
5 311 Medium management section
511 Listing UI section
512 Listing medium notification section
711 Bidding UI section
712 Out-of-successful bid range reception section
713 Successful bid result reception section

1. A system comprising:
a listing medium information acquisition section that acquires, from a listing user who lists at least one listing medium which is listed in an auction, listing medium information indicating the at least one listing medium;
a bid price information acquisition section that acquires bid price information indicating a bid price of at least one bid user who bids in the auction;
an immediate decision condition acquisition section that acquires immediate decision condition information indicating an immediate decision condition for determining a successful bid user who successfully bids for the at least one listing medium before a deadline set in advance as a bidding deadline for the auction expires;
a status information acquisition section that acquires status information indicating a status of the auction;
an immediate decision instruction information acquisition section that acquires immediate decision instruction information indicating an immediate decision instruction to, in a case where the status information has specific content set in advance, execute a bid which satisfies the immediate decision condition;
an immediate decision management section that, in a case where the status information has the specific content set in advance, executes, on the basis of the immediate decision instruction information, the bid which satisfies the immediate decision condition; and
a successful bid user determination section that, on the basis of the bid which has been executed by the immediate decision management section and which satisfies the immediate decision condition, determines, as a successful bid user who successfully bids for the at least one listing medium, the at least one bid user who is associated with the immediate decision instruction information.

2. The system as set forth in claim 1, wherein
the listing medium information acquisition section acquires, from the listing user, the listing medium information indicating a plurality of listing media which the at least one listing medium comprises, which have an identical type, and which are listed in one auction,
the bid price information acquisition section acquires the bid price information indicating the bid price of each of a plurality of bid users which the at least one bid user comprises,
the successful bid user determination section determines, among the plurality of bid users, a plurality of successful bid users who successfully bid for at least some of the plurality of listing media,
the status information includes information indicating a remaining number obtained by subtracting, from the number of the plurality of listing media, the number of listing media for which a successful bid has been made, and
the immediate decision instruction information is information indicating an instruction to, in a case where the remaining number is not more than a prescribed number, execute the bid which satisfies the immediate decision condition.

3. The system as set forth in claim 1, wherein
the status information includes information indicating a bid price of another bid user, and
the immediate decision instruction information is information indicating an instruction to, in a case where the bid price is not less than a prescribed amount, execute the bid which satisfies the immediate decision condition.

4. The system as set forth in claim 1, wherein
the status information includes information indicating the number of the at least one bid user who bids in the auction, and
the immediate decision instruction information is information indicating an instruction to, in a case where the number of the at least one bid user is not less than a prescribed number, execute the bid which satisfies the immediate decision condition.

5. The system as set forth in claim 1, wherein
the status information includes information indicating remaining time until the deadline set in advance expires, and
the immediate decision instruction information is information indicating an instruction to, in a case where the remaining time is not more than a prescribed time, execute the bid which satisfies the immediate decision condition.

6. The system as set forth in claim 1, wherein
the listing medium information acquisition section acquires, from the listing user, the listing medium information indicating a plurality of listing media which the at least one listing medium comprises, which have an identical type, and which are listed in one auction,
the bid price information acquisition section acquires the bid price information indicating the bid price of each of a plurality of bid users which the at least one bid user comprises, and
the successful bid user determination section determines, among the plurality of bid users, a plurality of successful bid users who successfully bid for at least some of the plurality of listing media.

7. The system as set forth in claim 1, further comprising:
a rank information acquisition section that acquires rank information indicating a rank of the bid price information in descending order of the bid price; and
an automated bidding management section that, until a termination condition under which a bidding period for the auction ends is satisfied, (i) determines, on the basis of advance setting by the at least one bid user who is associated with the bid price information, whether it is possible to update the bid price indicated by the bid price information whose rank is outside a successful bid range set on the basis of the number of the at least one listing medium to a bid price for the rank to be within the successful bid range, and (ii) updates the bid price in a case where the bid price is determined to be updatable.

8. The system as set forth in claim 1, wherein the at least one listing medium is an electronic medium with which a non-fungible token whose owner is managed on a blockchain is associated.

9. A method carried out by at least one computer, said method comprising:
a listing medium information acquisition step of acquiring, from a listing user who lists at least one listing medium which is listed in an auction, listing medium information indicating the at least one listing medium;
a bid price information acquisition step of acquiring bid price information indicating a bid price of at least one bid user who bids in the auction;
an immediate decision condition acquisition step of acquiring immediate decision condition information indicating an immediate decision condition for determining a successful bid user who successfully bids for the at least one listing medium before a deadline set in advance as a bidding deadline for the auction expires;
a status information acquisition step of acquiring status information indicating a status of the auction;
an immediate decision instruction information acquisition step of acquiring immediate decision instruction information indicating an immediate decision instruction to, in a case where the status information has specific content set in advance, execute a bid which satisfies the immediate decision condition;
an immediate decision management step of, in a case where the status information has the specific content set in advance, executing, on the basis of the immediate decision instruction information, the bid which satisfies the immediate decision condition; and
a successful bid user determination step of, on the basis of the bid which has been executed by the immediate decision management step and which satisfies the immediate decision condition, determining, as a successful bid user who successfully bids for the at least one listing medium, the at least one bid user who is associated with the immediate decision instruction information.

10. A non-transitory storage medium storing therein a program for causing at least one computer to carry out:
a listing medium information acquisition step of acquiring, from a listing user who lists at least one listing medium which is listed in an auction, listing medium information indicating the at least one listing medium;
a bid price information acquisition step of acquiring bid price information indicating a bid price of at least one bid user who bids in the auction;
an immediate decision condition acquisition step of acquiring immediate decision condition information indicating an immediate decision condition for determining a successful bid user who successfully bids for the at least one listing medium before a deadline set in advance as a bidding deadline for the auction expires;
a status information acquisition step of acquiring status information indicating a status of the auction;
an immediate decision instruction information acquisition step of acquiring immediate decision instruction information indicating an immediate decision instruction to, in a case where the status information has specific content set in advance, execute a bid which satisfies the immediate decision condition;
an immediate decision management step of, in a case where the status information has the specific content set in advance, executing, on the basis of the immediate decision instruction information, the bid which satisfies the immediate decision condition; and
a successful bid user determination step of, on the basis of the bid which has been executed by the immediate decision management step and which satisfies the immediate decision condition, determining, as a successful bid user who successfully bids for the at least one listing medium, the at least one bid user who is associated with the immediate decision instruction information.
